(19) United States
(12) Patent Application Publication
(10) Pub. No.: US 2012/0197539 A1
(43) Pub. Date: Aug. 2, 2012

(54) METHODS FOR DIAGNOSIS, TREATMENT AND MONITORING OF PATIENT HEALTH USING METABOLOMICS

(76) Inventor: Carolyn Slupsky, Davis, CA (US)

(21) Appl. No.: 13/500,903

(22) PCT Filed: Oct. 12, 2010
(86) PCT No.: PCT/CA2010/001583

§ 371 Date: Apr. 6, 2012

Related U.S. Application Data
(60) Provisional application No. 61/250,433, filed on Oct. 9, 2009.
(60) Provisional application No. 61/250,410, filed on Nov. 17, 2009.
(60) Provisional application No. 61/359,295, filed on Jun. 28, 2010.
(60) Provisional application No. 61/375,221, filed on Aug. 19, 2010.

(51) Int. Cl. G06F 19/00; G01N 27/74

(52) U.S. Cl. 702/19; 436/90; 436/93

(57) ABSTRACT

A method for assessing patient health is provided using metabolomics. The method comprises providing a bodily fluid or tissue sample from a subject, collecting a metabolic profile from the bodily fluid or tissue sample and comparing the metabolic profile to a reference profile, wherein the preferred bodily fluid is urine. Reference profiles are also provided.

### FIELD

The present technology relates to metabolomics. More specifically, the technology relates to the use of metabolomics to characterize metabolite profiles in bodily fluids and to correlate those profiles with disease states, conditions and body disorders.

### BACKGROUND

Typically individuals are diagnosed for various diseases using many tests that measure one outcome that may reflect the explicit presence or consequence of pathogens, toxins, nutrient deficiencies or cellular dysregulation. However, many of these tests are neither sensitive nor specific enough to unequivocally provide an accurate diagnosis. For example, the concentration of a single metabolite could be indicative of a variety of conditions just as blood pressure or heart rate can be an indicator of many conditions and thus not very specific. It requires special skill to combine many of these tests with other observations to make a judgment as to diagnosis.

Metabolomics is an emerging science dedicated to the global study of metabolites—their composition, dynamics, and responses to disease or environmental changes in cells, tissues, and biofluids. The metabolome is the collection of all metabolites resulting from all metabolic processes including energy transformation, anabolism, catabolism, absorption, distribution, and detoxification of natural and xenobiotic materials. With continuous fluxes of metabolic and signaling pathways, the metabolome is a dynamic system, wherein complex time-related changes may be observed reflecting the proteomic, transcriptomic and genomic state of the cell. Rather than focusing on individual metabolic pathways, in analogy to gene array studies, metabolomics permits unbiased, broad-based investigations of the study of multi-faceted alterations in metabolism.

PCT Patent Publication No. WO/2008/124920 (Slupsky et al.) entitled “Urine based detection of a disease state caused by a pneumococcal infection” describes the use of metabolomics to diagnose a pneumococcal infection. U.S. Pat. No. 7,373,256 (Nicholson et al.) entitled “Method for the identification of molecules and biomarkers using chemical, biochemical and biological data” describes a method of analyzing spectral data to identify biomarkers. The article Lyndon et al. “Metabonomics technologies and their application in physiological monitoring, drug safety assessment and disease diagnosis”, Biomarkers, vol. 9, no. 1, (January-February 2004) p. 1-31, describes the application of metabonomics to physiological evaluation, diagnosis, and other purposes. The article Weljie et al “Targeted Profiling: Quantitative analysis of ¹H NMR metabolomics data”, Anal. Chem. vol. 78 (2006), p. 4430-4442, describes how information may be extracted from complex spectroscopic data of metabolite mixtures. U.S. Pat. Nos. 7,191,069 and 7,181,348 (Wishart et al.), each entitled “Automatic identification of compounds in a sample mixture by means of NMR spectroscopy” describes a process by which metabolites are identified in a sample.

### SUMMARY

The present technology is directed to methods for the detection and monitoring (progression/regression) of disease states, conditions and body disorders based on the measurement, using NMR, of a number of common metabolites present in urine and other body fluids and tissues. These methods may be used as prognostic and treatment indicators. The methods are relatively rapid, and accurate. These advantages are obtained because of the selected group of metabolites of the present technology, as well as the method for measuring the selected group of metabolites. Depending upon the disease or body disorder, either the entire complement of metabolites or a subgroup of the complement of metabolites can be used for testing.

According to an aspect, there is provided a method for assessing patient health comprising: providing a bodily fluid or tissue sample from a subject; collecting a metabolic profile from the bodily fluid or tissue sample, the metabolic profile comprising two or more metabolites; and comparing the metabolic profile to at least one reference profile to assess the health of the subject. The at least one reference profile profiling at least one of: one or more disease, injury or disorder of the blood and blood-forming organs, one or more immune mechanism disorder, one or more auto-immune disease, one or more endocrine system disease, injury or disorder, one or more nutritional disease, one or more metabolic disease, one or more disease, injury or disorder of the nervous system, one or more disease, injury or disorder of the eye, one or more disease, injury or disorder of the adnexa of eye, one or more disease, injury or disorder of the ear, one or more disease, injury or disorder of the mastoid process, one or more disease, injury or disorder of the circulatory system, one or more disease, injury or disorder of the digestive system, one or more disease, injury or disorder of the skin and subcutaneous tissue, one or more disease, injury or disorder of the musculoskeletal system and connective tissue, one or more disease, injury or disorder of the genitourinary system, one or more viral infection of the respiratory system, one or more chronic disorder of the respiratory system, tuberculosis, and one or more neoplasm.

According to another aspect, the at least one reference profile may be at least one of ovarian cancer, breast cancer, and colon cancer, tuberculosis, hepatitis C, cirrhosis, fractures, myocardial infarcts, lacerations, congestive heart failure, fasting, Mycobacterium tuberculosis, Legionella pneumophila, Coxiella burnetii, Staphylococcus aureus, Mycoplasma pneumoniae, and Haemophilus influenza, influenza A, parainfluenza, respiratory syncycial virus (RSV), picorna virus, corona virus, rhinovirus, human metapneumovirus (hMPV) and hantavirus.

According to another aspect, the method may further comprise statistically analyzing differences between the metabolic profile and reference profile to identify at least one biomarker. Biomarkers or a group of biomarkers having a significance level of less than 95%, 97%, 98% or 99% may be rejected.

According to another aspect, the metabolites of at least one of the metabolic profile and the reference profile may be selected from a groups consisting of 1,3-dimethylurate, levoglucosan, 1-methylnicotinamide, metabolite 1,2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2, metabolite 3, hippurate, histidine, hypoxanthine, isoleucine, lactate, leucine, lysine, mannitol, metabolite 4, metabolite 5, metabolite 6, N,N-dimethylglycine, O-acetylcarnitine, pantothenate, propylene glycol, pyroglutamate, pyruvate, quinolinate, serine, succinate, sucrose, metabolite 7, taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

According to another aspect, the bodily fluid may be urine.

According to another aspect, the profiles may be obtained using Nuclear Magnetic Resonance spectroscopy.

According to another aspect, the reference profile may be established from the metabolic profile collected from subjects with the same disease, from a healthy population, or both.

According to another aspect, the method may further comprise monitoring by repeatedly comparing, over time, the metabolic profile to the reference profile.

According to another aspect, the subject may be metabolically stressed.

According to another aspect, the method may further comprise the steps of: treating the subject at least one of before and after providing at least one bodily fluid sample from the subject; and comparing the metabolic profile to a reference profile to assess the efficacy or toxicity of the treatment in treating the subject.

According to another aspect, there is provided a kit for performing the method, wherein the kit comprises the reference biomarkers and necessary reagents for performing the analysis.

According to another aspect, there is provided a reference profile for assessing patient health, the profile comprising at least one biomarker that is defined as being differentially present at a level that is statistically significant, the profile profiling at least one of one or more disease, injury or disorder of the blood and blood-forming organs, one or more immune mechanism disorder, one or more auto-immune disease, one or more endocrine system disease, injury or disorder, one or more nutritional disease, one or more metabolic disease, one or more disease, injury or disorder of the nervous system, one or more disease, injury or disorder of the eye, one or more disease, injury or disorder of the adnexa of eye, one or more disease, injury or disorder of the ear, one or more disease, injury or disorder of the mastoid process, one or more disease, injury or disorder of the circulatory system, one or more disease, injury or disorder of the digestive system, one or more disease, injury or disorder of the skin and subcutaneous tissue, one or more disease, injury or disorder of the musculoskeletal system and connective tissue, one or more disease, injury or disorder of the genitourinary system, one or more viral infection of the respiratory system, one or more chronic disorder of the respiratory system, tuberculosis, and one or more neoplasm.

According to another aspect, the reference profile may be obtained from a urine sample.

According to another aspect, there is provided a method of characterizing a metabolite in a sample, comprising the steps of: providing a bodily fluid or tissue sample from a subject; analyzing the bodily fluid or tissue sample to obtain spectral data of the sample; processing the spectral data using baseline correction and line width normalization; and comparing the processed spectral data to at least one reference spectrum to characterize the metabolite.

According to another aspect, the method may comprise the step of characterizing a plurality of metabolites in the sample to obtain a metabolic profile of the sample.

According to another aspect, the processed spectral data may be compared to a mathematical representation of the reference spectrum.

According to another aspect, the method may further comprise the steps of applying an apodization function, the spectral data may be phase shifted, and obtaining the spectral data may comprise zero-filling or linear prediction.

According to another aspect, the metabolic profile may comprise a reference profile of a disease, injury or disorder of the blood and blood-forming organs, an immune mechanism disorder, an auto-immune disease, an endocrine system disease, injury or disorder, a nutritional disease, a metabolic disease, a disease, injury or disorder of the nervous system, a disease, injury or disorder of the eye, a disease, injury or disorder of the adnexa of eye, a disease, injury or disorder of the ear, a disease, injury or disorder of the mastoid process, a disease, injury or disorder of the circulatory system, a disease, injury or disorder of the digestive system, a disease, injury or disorder of the skin and subcutaneous tissue, a disease, injury or disorder of the musculoskeletal system and connective tissue, a disease, injury or disorder of the genitourinary system, a viral infection of the respiratory system, a chronic disorder of the respiratory system, tuberculosis, and a neoplasm.

According to another aspect, the metabolic profile comprises two or more of 1,3-dimethylurate, levoglucosan, 1-methylnicotinamide, metabolite 1,2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2, metabolite 3, hippurate, histidine, hypoxanthine, isoleucine, lactate, leucine, lysine, mannitol, metabolite 4, metabolite 5 (which may be methylamine), metabolite 6 (which may be methylguanidine), N,N-dimethylglycine, O-acetylcarnitine, pantothenate, propylene glycol, pyroglutamate, pyruvate, quinolinate, serine, succinate, sucrose, metabolite 7 (which may be tartrate), taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

According to another aspect, the spectral data is obtained using Nuclear Magnetic Resonance spectroscopy.

According to another aspect, the method further comprises the step of characterizing more than one metabolite using relative peak position, J-coupling, and line width information.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a graph depicting the phase correction of a peak.

FIG. 2 are graphs depicting the ffect of pH and ionic strength on NMR spectra. (A) Change in chemical shift of the single peak of fumarate with increasing pH. (B) Change in chemical shift, linewidth, and J-coupling of citrate peaks with changes in ionic strength, in this case increasing concentration of calcium.

FIG. 3 are graphs depicting the effect of baseline correction and reference deconvolution on NMR spectral fitting. NMR spectrum showing region from 0.96 to 1.05 ppm from internal standard with no baseline correction applied (A), baseline correction applied (B), or baseline correction and reference deconvolution applied (C). Dotted line represents actual NMR spectral region, grey line represents simulated spectral fit, and dark line represents spectral subtraction (simulated spectrum-actual spectrum).

FIG. 4 depicts ¹H NMR spectral fitting of a single compound. Shown are the Hα, Hβ, CH₃γ1, and CH₃γ2 protons of valine.

FIG. 5 is a graph of chemical shift versus pH for fumarate.

FIG. 6 shows urinary metabolite profiles derived from subjects having either bacterial pneumonia (from pathogens such as Streptococcus pneumoniae, Staphylococcus aureus, Haemophilus influenzae, Mycoplasma pneumoniae, Escherichia coli, and others) or those without pneumonia. PLS-DA model illustrates the difference between “Healthy” (▪) versus those with bacterial pneumonia (◯).

FIG. 7 shows urinary metabolite profiles derived from subjects having either viral pneumonia (caused from pathogens such as influenza A, respiratory syncycial virus (RSV), parainfluenza, picorna virus, corona virus, rhinovirus, and human metapneumovirus (hMPV)) or those without pneumonia. PLS-DA model illustrates the difference between “Healthy” (▪) versus those with viral pneumonia (◯).

FIG. 8 is a comparison of urinary metabolite profiles derived from subjects with bacterial or S. pneumoniae pneumonia with healthy subjects and subjects with viral pneumonia. PLS-DA model shows “Healthy” (▪), bacterial or S. pneumoniae pneumonia (◯) or viral pneumonia (♦).

FIG. 9 is a comparison of urinary metabolite profiles derived from subjects with active Mycobacterium tuberculosis infection (♦) versus healthy (▪) and all other forms of community acquired pneumonia (◯).

FIG. 10 is a comparison of active M. tuberculosis (◯) with latent M. tuberculosis (♦) and a “Healthy” population (▪).

FIG. 11 is a comparison of urinary metabolite profiles derived from individuals with Coxiella burnetii infection (Q-fever) (♦) with S. pneumoniae (◯) and normal, “healthy” individuals (▪).

FIG. 12 is a comparison of urinary metabolite profiles derived from individuals with Legionella pneumophila (◯ or ♦) with normal (▪) and S. pneumoniae (◯).

FIG. 13 is a comparison of urinary metabolite profiles derived from normal (▪) and those with S. pneumoniae pneumonia (◯) and those with ER stress (derived from individuals presenting with fractures, myocardial infarcts, lacerations, congestive heart failure, and others) (▾).

FIG. 14 is a comparison of urinary metabolite profiles derived from individuals with S. pneumonia pneumonia (◯), healthy individuals (▪), and those with liver disease (hepatitis C or cirrhosis) (♦).

FIG. 15 is a comparison of urinary metabolite profiles derived from individuals with Chronic Obstructive Pulmonary Disease (COPD) or Asthma (◯), S. pneumoniae pneumonia (♦), and healthy individuals (▪).

FIG. 16 are graphs showing glutamine and quinolinate levels in comparison to known “normal” levels in the cerebrospinal fluid and urine during progression of rabies in a single patient.

FIG. 17 are graphs showing five metabolite levels, in comparison to known levels of these metabolites in a normal population (normal, ▪) and a population with bacteremic pneumococcal pneumonia (spn, ▪), in the urine of a single patient recovering from Streptococcus pneumoniae pneumonia.

FIG. 18 shows urinary metabolite profiles derived from patients with pneumonia caused by S. pneumoniae compared to healthy subjects, subjects with non-infectious metabolic stress, fasting subjects, and subjects with liver dysfunction. a, PCA model (based on 61 measured metabolites) of age- and gender-matched “healthy” subjects versus those with pneumococcal pneumonia. “Healthy” subjects (▪, n=47); bacteremic pneumococcal pneumonia (, n=32); sputum or endotracheal tube positive S. pneumoniae cultures (♦, n=15). b, PCA model as in a with removal of diabetics (8 pneumonia patients, and 3 “healthy” subjects) from the data set. c, OPLS-DA model based on 61 measured metabolites using all “healthy” subjects (n=118 (▪)) and S. pneumoniae infected patients (n=62 ()), (R²=0.902; Q²=0.820). d, Loadings plot derived from OPLS-DA plot in c. e, OPLS-DA prediction of two patients (yellow triangles indicated with *) with positive sputum culture, but no other evidence of lung infection. f, OPLS-DA model based on 61 measured metabolites of an S. pneumoniae infected group (n=62 (♦)), and non-infectious metabolic stress (n=56 ()), (R²=0.828; Q²=0.655). g, OPLS-DA model based on 61 measured metabolites of individuals with pneumococcal pneumonia (infected) (n=62 (♦)), and a group of fasting individuals (n=70, ()), (R²=0.877; Q²=0.842). h, OPLS-DA model based on 61 measured metabolites of individuals with pneumococcal pneumonia (infected) (n=62 (▪)), and a group with liver disease (Hepatitis C and cirrhosis) (n=16, ()), (R²=0.936; Q²=0.899).

FIG. 19 are graphs comparing pneumonia caused by Streptococcus pneumoniae with other pulmonary diseases. a, OPLS-DA model based on 61 measured metabolites comparing S. pneumoniae patients (n=62, (▪)), to patients with asthma exacerbation (n=29, ()), (R²=0.776; Q²=0.676). b, OPLS-DA model based on 61 measured metabolites comparing S. pneumoniae patients (n=62, (▪)), to patients with COPD exacerbation (n=44, ()), (R²=0.804; Q²=0.638).

FIG. 20 are graphs comparing pneumonia caused by Streptococcus pneumoniae with viral and other bacterial forms of pneumonia. a, OPLS-DA model based on 61 measured metabolites comparing S. pneumoniae patients (n=62, (▪)), to patients with viral pneumonia (n=57, ()), (R²=0.665; Q²=0.486). b, OPLS-DA model based on 61 measured metabolites comparing S. pneumoniae patients (n=62, (▪)), to patients with pulmonary M. tuberculosis (n=65, ()), (R²=0.840; Q²=0.774). c, OPLS-DA model based on 61 measured metabolites comparing S. pneumoniae patients (n=62, (▪)), to patients with L. pneumophila (n=62, ()), (R²=0.627; Q²=0.458). d, OPLS-DA model based on 61 measured metabolites comparing S. pneumoniae patients (n=62, (▪)), to patients with other bacterial pneumonia (n=80, ()) (S. aureus (n=27), C. burnetii (n=15), H. influenzae (n=11), M. pneumoniae (n=9), E. coli (n=7), E. faecalis (n=3), M. catarrhalis (n=4), S. viridans (n=2), and S. anginosus (n=2)), (R²=0.744; Q²=0.680).

FIG. 21 depicts the change in profiles over time. OPLS-DA statistical analysis compares control subjects (n=118 (▪)) with pneumococcal pneumonia patients (n=62, ( [symbol] )). a, Study with 2 urine samples collected. Patient 1, day 3 and day 18; patient 2, day 1 and day 17; patient 3 day 4 and day 30; patient 4 day 1 and day 11; patient 5 day 0 and day 29. b, Study with three patients and 4 to 6 urine collections. Patient 6, day 1, day 20, day 34, and day 62; patient 7 day 0, day 2, day 4, day 6, day 29, and day 58; patient 8 day 2, day 4, day 7 and day 14.

FIG. 22 are graphs representing the sensitivity and specificity in a blinded test set. a, Prediction of classification of blinded test samples using a truncated set of metabolites (Table 1). “Healthy” subjects (n=118 (▪)), and S. pneumoniae infected patients (n=62 ()) represent the learning set. Pneumococcal pneumonia (n=35 (▴)) and other (n=110 (▴)) represent the test set which includes healthy subjects as well as those with a variety of other illnesses. b, Receiver operating characteristic curve (ROC) is defined as sensitivity vs 1-specificity.

FIG. 23a is a graph showing urinary metabolite profiles derived from ovarian cancer subjects (◯) compared to healthy subjects (▪).

FIG. 23b is a graph of the statistical validation of the corresponding PLS-DA model by permutation analysis, where R² is the explained variance, and Q² is the predictive ability of the model.

FIG. 23c is a graph of the OPLS-DA prediction of 20 additional subjects (10 each of healthy, indicated by a star, and ovarian cancer subjects, indicated by a triangle).

FIG. 24a is a graph showing urinary metabolite profiles derived from breast cancer subjects (◯), and healthy female subjects (▪).

FIG. 24b is a graph of the statistical validation of the corresponding PLS-DA model by permutation analysis.

FIG. 24c is a graph of the OPLS-DA prediction of 20 additional subjects (10 each of healthy, indicated by a star and breast cancer subjects, indicated by a triangle).

FIG. 25 are graphs of urinary metabolite profiles derived from subjects with breast and ovarian cancer are different. (A) OPLS-DA model (based on 67 measured metabolites) comparing 48 breast cancer (◯) and 50 ovarian cancer (▪) subjects (R²=0.55; Q²=0.48). (B) Statistical validation of the OPLS-DA model by permutation analysis.

FIG. 26 is a graph comparing ovarian cancer (▪) and colon cancer (◯).

FIG. 27 is a graph comparing ovarian cancer (▪) and lung cancer (◯).

FIG. 28 is a graph comparing colon cancer (▪) and lung cancer (◯).

### DETAILED DESCRIPTION

Metabolomics is more powerful than genomics as it is not limited to specific diseases that have a genetic component. Rather, any perturbation of cellular metabolism caused by the presence of a bacterium, virus, cancer, or the presence of a disease including, but not limited to, immunological diseases, including allergic diseases, gastrointestinal disorders, body weight disorders, cardiovascular disorders, pulmonary disorders, or central nervous system disorders may be observed or monitored.

Current state of the art for measuring metabolites involves using one of or a combination of Mass Spectrometry (MS) coupled with gas chromatography (GC-MS) or liquid chromatography (LC-MS), high performance liquid chromatography (HPLC), or nuclear magnetic resonance (NMR) spectroscopy. All can be powerful analytical tools when combined with multivariate statistical analyses. However, while GC-MS, LC-MS, or HPLC can be used for measuring metabolite concentrations in the sub-micromolar range, the measurement of even 40 metabolite concentrations from a number of samples by MS is laborious, requiring multiple internal standards and a significant amount of time.

NMR spectroscopy is an ideal method for performing metabolomic studies, as it allows for a large number of metabolites to be quantified simultaneously without the need for a priori separation of compounds of interest by chromatographic methods or derivitization to facilitate detection or separation. Furthermore, only one internal standard is required. This allows study of all metabolic pathways without pre-conceptions as to which pathways are likely to be affected. However, despite the advantages of this technique, NMR has not been used extensively in the past because manual analysis of the complex spectrum requires a skilled technician and can be time consuming since a ¹H NMR spectrum of a biofluid or tissue is extremely complex, consisting of thousands of signals. Deconvolution of these signals into discrete metabolites with corresponding concentrations requires considerable skill and knowledge that is not generally known in the art. For this reason, the technique of spectral binning has been used to identify regions of a spectrum containing peaks that differ between two different states. However, this technique has not realized any useful diagnostic tests to date since raw NMR spectral data provide no a priori information on the metabolites of interest that differentiate the sample classes. These types of analyses are difficult at best as ¹H NMR is very sensitive to sample conditions such as pH and ionic strength. Moreover, in complex systems such as human blood and urine, the spectra are often complicated by xenobiotic materials.

Multivariate statistical analysis, including principal component analysis (PCA), partial least-squares-discriminant analysis (PLS-DA), or orthogonal partial least-squares-discriminant analysis (OPLS-DA) can be applied to the collected data or complex spectral data to aid in the characterization of changes related to a biological perturbation or disease.

### DEFINITIONS

The following definitions are provided solely to aid the reader. These definitions should not be construed to provide a definition that is narrower in scope than would be apparent to a person of ordinary skill in the art.

Body disorder—Body disorder is any non-infectious disease including, but not limited to Crohn's Disease, ulcerative colitis, chronic obstructive pulmonary disease (COPD), etc.

Condition—A condition includes healthy, or metabolically stressed, wherein metabolically stressed includes, for example, but not limited to, obese, pregnant, anorexic, bulemic, cachexic, diabetic, liver disease (e.g. cirrhosis), having myocardial infarction, having congestive heart failure and trauma, fasting, etc. Conditions may also include other types of diseases, disorders or injuries, such as diseases, disorders or injuries of the blood and blood-forming organs, immune mechanism disorders, auto-immune diseases, endocrine system diseases, disorders or injuries, nutritional diseases, metabolic diseases, diseases, disorders or injuries of the nervous system, diseases, disorders or injuries of the eye, diseases, disorders or injuries of the adnexa of eye, diseases, disorders or injuries of the ear, diseases, disorders or injuries of the mastoid process, diseases, disorders or injuries of the circulatory system, diseases, disorders or injuries of the digestive system, diseases, disorders or injuries of the skin and subcutaneous tissue, diseases, disorders or injuries of the musculoskeletal system and connective tissue, diseases, disorders or injuries of the genitourinary system, viral infections of the respiratory system, chronic disorders of the respiratory system, other infections such as tuberculosis, and one or more neoplasms or cancers, such as breast cancer, ovarian cancer, colon cancer, etc. It will be understood that the types of diseases, injuries and disorders cannot be practically listed here. Specific diseases, injuries and disorders that are discussed below include ovarian cancer, breast cancer, and colon cancer, tuberculosis, hepatitis C, cirrhosis, fractures, myocardial infarcts, lacerations, congestive heart failure, fasting, Mycobacterium tuberculosis, Legionella pneumophila, Coxiella burnetii, Staphylococcus aureus, Mycoplasma pneumoniae, and Haemophilus influenza, influenza A, parainfluenza, respiratory syncycial virus (RSV), picorna virus, corona virus, rhinovirus, human metapneumovirus (hMPV) and hantavirus.

Patient health—Patient health can be defined as at least one of:
infectious disease state, whether diseased or otherwise, further including the range of disease, from mild to moderate to acute, including more than one infectious disease state;
condition, including healthy, or metabolically stressed, wherein metabolically stressed includes, for example, but not limited to, obese, pregnant, anorexic, bulemic, cachexic, diabetic, having myocardial infarction, having congestive heart failure and trauma, including more than one condition;
body disorders (non-infectious diseases) including, but not limited to, inflammatory bowel disease, including Crohn's Disease and ulcerative colitis, chronic obstructive pulmonary disease (COPD) and liver disease (e.g. cirrhosis), including more than one body disorder; and
cancer including, but not limited to, ovarian cancer and breast cancer, including more than one type of cancer.

Bodily fluid—Bodily fluid includes, for example, but not limited to, follicular fluid, seminal plasma, uterine lining fluid, urine, plasma, blood, spinal fluid, serum, interstitial fluid, sputum, saliva.

Metabolite—In the context of the present technology, metabolites include 1,3-dimethylurate, levoglucosan, 1-methylnicotinamide, metabolite 1 (which may be 2-aminobutyrate), 2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2 (which may be glycolate), metabolite 3 (which may be guanidoacetate), hippurate, histidine, hypoxanthine, isoleucine, lactate, leucine, lysine, mannitol, metabolite 4 (which may be methanol), metabolite 5 (which may be methylamine), metabolite 6 (which may be methylguanidine), N,N-dimethylglycine, O-acetylcarnitine, pantothenate, propylene glycol, pyroglutamate, pyruvate, quinolinate, serine, succinate, sucrose, metabolite 7 (which may be tartrate), taurine, threonine, trigonelline, trimethylamine-N-oxide, tryptophan, tyrosine, uracil, urea, valine, xylose, cis-aconitate, myo-inositol, trans-aconitate, 1-methylhistidine, and 3-methylhistidine. In addition, the following metabolites may also be present: ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol. Metabolites 1 through 7 have been characterized, but not identified with certainty to date. Unknown metabolite 1 is a triplet centered at approximately 0.97 ppm, unknown metabolite 2 is a singlet centered at 3.94 ppm, unknown metabolite 3 is a singlet centered at 3.79 ppm, unknown metabolite 4 is a singlet centered at 3.35 ppm, unknown metabolite 5 is a singlet centered at 2.60 ppm, unknown metabolite 6 is a singlet centered at 2.82 ppm, and unknown metabolite 7 is a singlet centered at 4.33 ppm.

Small molecule—Small molecules in the context of the present technology include organic molecules that are found in bodily fluid and that are derived in vivo from metabolites. To be clear, they include organic molecules from the subject and from bacteria, viruses, fungi and other microbes in the subject. Examples of small molecules include sugars, fatty acids, amino acids, nucleotides, intermediates formed during cellular processes, and other small molecules found in vivo. They may also include molecules not formed, but ingested and metabolized within the body which would include drugs and food metabolites.

Metabolic profile—In the context of the present technology, the metabolic profile is the relative level of at least one of the metabolites, and small molecules derived therefrom.

Biomarker—A biomarker is a metabolite or small molecule derived therefrom, that is differentially present (i.e., increased or decreased) in a biological sample from a subject or a group of subjects having a first phenotype (e.g., having a disease) as compared to a biological sample from a subject or group of subjects having a second phenotype (e.g., not having the disease). A biomarker may be differentially present at any level, but is generally present at a level that is increased by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, by at least 100%, by at least 110%, by at least 120%, by at least 130%, by at least 140%, by at least 150%, or more; or is generally present at a level that is decreased by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, or by 100% (i.e., absent). A biomarker is preferably differentially present at a level that is statistically significant.

Statistically significant—In the context of the present technology, statistically significant means at least about a 95% confidence level, preferably at least about a 97% confidence level, more preferably at least about a 98% confidence level and most preferably at least about a 99% confidence level, as determined using parametric or non-parametric statistics, for example, but not limited to ANOVA or Wilcoxon's rank-sum Test, wherein the latter is expressed as p<0.05 for at least about a 95% confidence level.

Reference profile—A reference profile is the metabolic profile that is indicative of a healthy subject or one or more of a disease state, condition or body disorder. Within the reference profile, there will be reference levels of one or more biomarkers (metabolites or small molecules derived therefrom) that may be an absolute or relative amount or concentration of the one or more biomarkers, a presence or absence of the one or more biomarkers, a range of amount or concentration of the one or more biomarkers, a minimum and/or maximum amount or concentration of the one or more biomarkers, a mean amount or concentration of the one or more biomarkers, and/or a median amount or concentration of the one or more biomarkers.

Level—The level of one or more biomarkers means the absolute or relative amount or concentration of the biomarker in the sample.

Reference equation—A mathematical expression describing relative chemical shift, J-coupling constant, linewidth (and related T₂ relaxation time), and amplitude (and related T₁ relaxation time) for a small molecule.

Spectral library—A collection of reference equations describing small molecules.

### Statistical Methods

There will now be given a description of an example of a general statistical method that can be used to analyze data from a sample to obtain a metabolomic profile. In the description below, it is assumed that NMR spectroscopy is used to collect the data. It will be understood that modifications may be made depending on the preferences of the user and the available resources.

The sample is prepared by centrifuging, taking an aliquot of sample, adding internal standard, and adjusting the pH into a specified reference range. A preferred pH is 6.8±0.2, but other pH's or larger ranges could be used as well. The NMR data may be acquired in various ways, but needs to be consistent with the way in which the spectral library containing reference spectra is collected. For instance, data may be collected with the first increment of a NOESY spectrum, with a 2.5 s acquisition time, and 2.5 s pre-acquisition delay, and a 100 ms mixing time, with saturation of the water during the pre-acquisition delay and mixing time.

Once the NMR spectral data is obtained, it may be analyzed using various steps and strategies, as outlined below.

Zero filling—Prior to Fourier Transformation, NMR time-domain data should be either zero-filled to at least 128,000 points, or linear predicted.

Fourier Transformation—A Fourier Transform is then applied, such as a Fast Fourier Transform to the time-domain data.

Apodization Function—Application of an apodization function to the NMR spectral data is important to ensure that the Lorentzian NMR peaks are brought down smoothly to zero with minimal sidelobes. The apodization function may consist of an exponential multiplier, sine or cosine multiplier, Gaussian multiplier or another such multiplier. Once chosen, the selection of the apodization function should match the apodization function used in generation of the NMR spectral library, and should be consistent throughout.

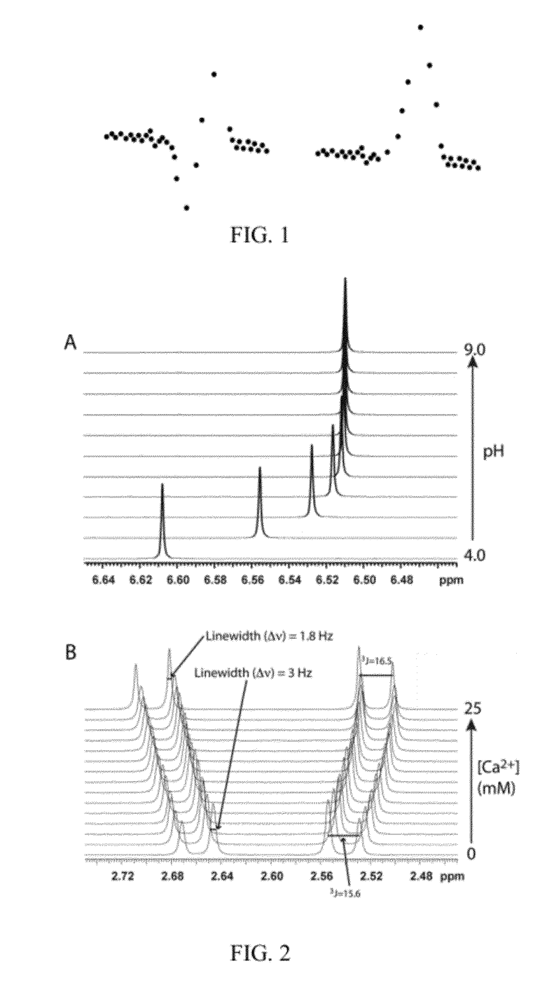

Phasing—All peaks (except water) should appear as Lorentzian peaks in an NMR spectrum with no dispersive component. Once an NMR spectrum has been Fourier Transformed and a suitable apodization function applied (such as an exponential multiplier), the phase of the peaks should be adjusted to be Lorentzian. An example is shown in FIG. 1, where the phase of the waveform on the left has been corrected to what is shown on the right.

Phasing may be done automatically. For automatic phasing, the zero-order and first-order phase corrections may be determined by minimizing entropy (the normalized derivative of the NMR spectral data). Other such techniques may be used as well.

A procedure for checking on whether the phasing needs adjusting may be as follows: Since an NMR spectrum (which may be collected and zero-filled to 128,000 points) is composed of 128,000 (x, y) points if an internal standard, such as DSS is present as the right-most peak, find the internal standard peak, and calculate the difference between the y-point between point (x, y) and point (x+n, y), where n is specified as an optimal number to give rise to a peak. If this difference is greater or less than a certain threshold, then the right-most peak is found.

It may be necessary to determine the absorptive and/or dispersive nature of peak. This is done by calculating whether the average y-value is either positive or negative, and on which side of the maximum it is positive or negative. This is the indication of the dispersive element. In order to phase the spectrum, the real and imaginary components need to be mixed, and the phase gives an indication of the amount of real and imaginary components that need to be mixed. Adjust the phase, and determine whether the peak still contains a dispersive component.

Once the zero-order phase correction has been found, find another peak on the left-hand of the spectrum, and determine the % dispersive character. Adjust the first-order correction. Then, go back to the right-most peak, and attempt to do a zero-order phase correction again. Repeat until all dispersive components are eliminated.

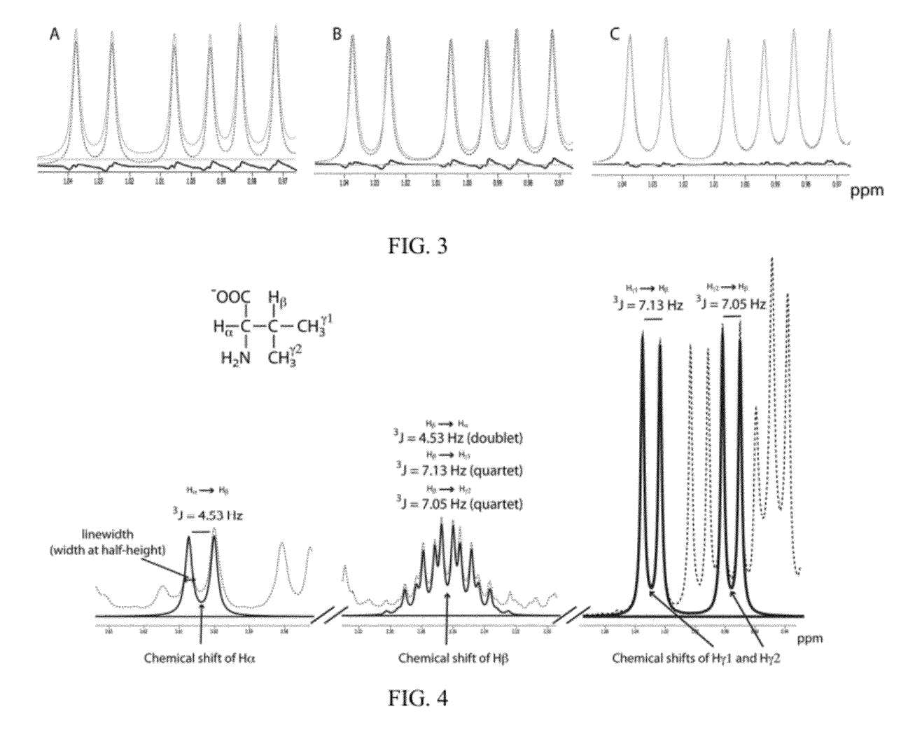

Baseline correction—Starting with a specified number of points, for example, between 1000 and 2000 points on either end of the spectrum, apply a spline fit (every 100 points, calculate the average y-value). Calculate the change in “y” between each point. At the middle of the spectrum (at the water peak), find the y-value over 0.2 ppm (+/−0.1 ppm from the center of the spectrum). On either side of the water peak, calculate the average y-value for a specified number of points at regular intervals, such as 500 points every 100 points. Create a smooth curve linking the right hand of the spectrum with the average points on the right hand side of the water, and another smooth curve linking the left hand side of the spectrum with the average points on the left hand side of the water. Subtract the curve (including the water) from the spectrum. An example of a baseline correction is shown in FIG. 3.

Linewidth normalization—To effectively ensure optimum resolution, and remove linewidth problems associated, for example, from badly shimmed spectra etc., apply reference deconvolution using a 1.3 Hz linewidth on the reference line with a width of +/−0.04 ppm. Once chosen, the selection of the linewidth normalization should match that used in generation of the NMR spectral library, and should be consistent throughout.

Spectral Analysis—Each small molecule reference spectrum may be represented as a mathematical formulation encompassing relative positions of peak multiplicities to one another within each molecule that are encoded specifically with J-coupling, and line width information. The J-coupling, linewidth, and relative position will vary with changes in pH and ionic strength of the solution, as shown in FIGS. 2 and 3. At 0 mM Ca²⁺, linewidth is 3 Hz, and J-coupling is 15.6 Hz whereas at 25 mM, linewidth is 1.8 Hz and J-coupling is 16.5 Hz. Both pH and ionic strength can affect chemical shift, linewidth and J-coupling. Quantitative information may be determined based on the area under each set of peaks representative of certain atoms or types of atoms in the molecule. The quantitative information can be specifically determined based on the relaxation properties of the molecule, or based on comparison to a reference peak.

Each reference spectrum representing a specific chemical that may or may not be present in a test spectrum will use this mathematical formulation to accomplish a best-fit to the spectrum of interest based on a statistical probability that the compound is present, which might be based on the type of sample, for example, and the statistical peak positions, linewidths, and J-couplings based upon analysis of thousands of similar spectra from similar types of samples, such as a urine sample for example. Statistical fitting of peaks in a spectrum will start with the most probable and most concentrated peaks such as urea, creatinine, creatine, citrate, glucose, alanine, lactate/threonine, etc. for urine or another peak set for serum, or another peak set defined by the user or defined based on statistics of the samples of interest, and working through a list of statistically probable metabolites that could be present. To fit, the difference between the library reference value and the spectrum will be calculated and adjusted to ensure a minimum non-negative subtraction line. Analysis will be continued from one metabolite to the next. Once all metabolites have been fit, the spectrum will be re-adjusted to optimize spectral subtraction, and optimize quantification. The optimization may encompass a least squares optimization, but may be any other type of optimization. During this process, the various metabolites are classified to identify whether they are present (or present in a measurable quantity). Preferably, this includes measuring the concentration as well.

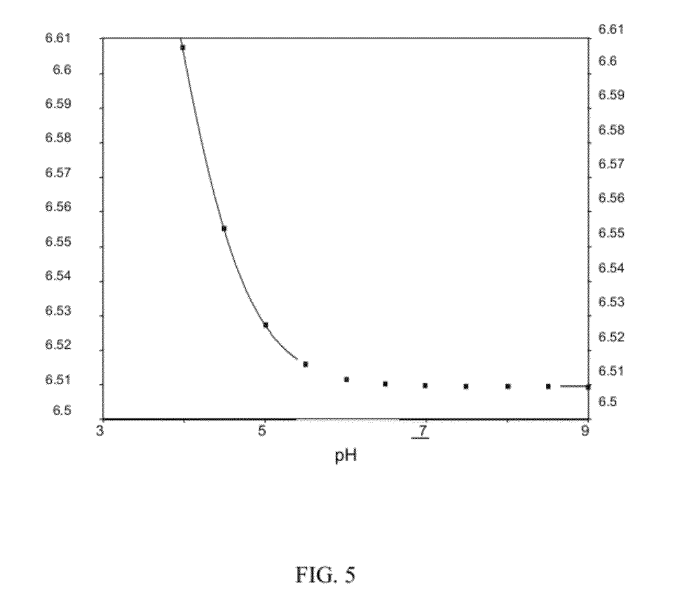

Referring to FIG. 4, an example of spectral fitting is shown, namely, the ¹H NMR spectral fitting of a single compound. Shown are the Hα, Hβ, CH₃γ1, and CH₃γ2 protons of valine. The NH₂ protons exchange with the solvent and are not visible. The methyl protons (at 0.97 and 1.03 ppm relative to the internal standard) couple only to Hβ, and are thus split into doublets by 7.05 and 7.13 Hz respectively. The Hα proton (at 3.604 ppm) is coupled only to Hβ, and is thus split into a doublet of 4.53 Hz. The Hβ proton is split into a doublet of 4.53 Hz by the Hα proton, and each doublet is split into a quartet by the CH₃-γ1 and another quartet by CH₃γ2 making the complex pattern observed. Linewidth and integrals are based on the number of H's represented by each peak (methyl peaks are 3 times the integral of the individual Hα and Hβ peaks), the relaxation properties (T₁ and T₂) of each atom (or group of atoms as in the case of the methyl group), and depend on field strength and pulse sequence. Since T₁ relaxation times are long for small molecules, pulse sequences with short relaxation times will attenuate the signals. By using the same pulse sequence as used for generation of the spectral equation library, and using an internal standard, these effects may be compensated for, and accurate quantitation may be obtained. Referring to FIG. 5, an example of the chemical shift versus pH is shown, in this case, for fumarate. From this graph, a mathematical equation may be developed which describes the chemical shift at different pH's. Similar mathematical equations may be determined for linewidth, J-coupling, and relaxation properties that take into account pH and/or ionic strength and/or temperature. Frequency may be described relative to an internal standard, or relative to other peaks within a spectrum.

Classification of Samples—After optimization of spectral data, tables consisting of reference data for which there is a disease state or a non-disease state or a related state will be created. Using normalization based on a core set of metabolites, normalize all metabolites in each sample using probabilistic quotient normalization. Subsequently, classify using, as an example, PLS-DA, or OPLS-DA, or support vector machines or another similar statistical method. Once a classification system has been defined, optimize the class by removing those features (metabolites) that do not aid in classification. For unknown classification, prepare data as described above, normalizing Test the data using the classifiers and classify.

### Example 1

A method to determine the disease state or body disorder through ¹H NMR analysis of urine from a patient is disclosed. Urine samples were tested for the relative levels of one or more metabolites (1,3-dimethylurate, levoglucosan, 1-methylnicotinamide, metabolite 1 (which may be 2-aminobutyrate), 2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2 (which may be glycolate), metabolite 3 (which may be guanidoacetate), hippurate, histidine, hypoxanthine, isoleucine, lactate, leucine, lysine, mannitol, metabolite 4 (which may be methanol), metabolite 5 (which may be methylamine), metabolite 6 (which may be methylguanidine), N,N-dimethylglycine, O-acetylcarnitine, pantothenate, propylene glycol, pyroglutamate, pyruvate, quinolinate, serine, succinate, sucrose, metabolite 7 (which may be tartrate), taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

Sample Collection

Written informed consent was obtained from each subject before entering this study, and institutional ethics committees approved the protocols outlined below.

Patients with pneumococcal disease (all pneumonia): Pneumonia was categorized as definite pneumococcal pneumonia: positive blood culture for S. pneumoniae (n=37); or possible pneumococcal pneumonia; positive sputum or endotracheal tube culture for S. pneumoniae only (n=15). All patients had a chest X-ray radiograph read as pneumonia by a radiologist. In addition, 2 of the blood positive patients had pneumococcal peritonitis (S. pneumoniae isolated from peritoneal fluid) and 2 of the blood-positive patients had meningitis (S. pneumoniae isolated from cerebrospinal fluid). S. pneumoniae was identified in microbiology laboratories of the University of Alberta Hospital and Mt. Sinai Hospital using standard criteria. For the entire group: n=52 (31 male, 21 female); mean age: 53±23; range: 6 days-88 years. Eight had diabetes mellitus, and three were pediatric patients.

Healthy volunteers: n=115, (45 male, 70 female); mean age: 59±14; range: 19-87. This group had 3 diabetics.

Non-infectious metabolic stress: Patients in this category were diagnosed with (1) myocardial infarction: n=12; (10 male, 2 female); mean age: 59±14, range: 41-76, (2) congestive heart failure: n=12; (7 male, 5 female); mean age: 78±9, range: 59-91, (3) trauma (fractures): n=17; (11 male, 6 female); mean age: 55±14, range: 22-76, (4) trauma (lacerations): n=14; (10 male, 4 female); mean age: 32±13, range: 19-57, and (5) other: n=1 (1 female); age=37. In all instances, the patient's attending physician made diagnoses of the above conditions. Patients in groups (1)-(3) had no obvious evidence of infection.

Fasting individuals: Patients presenting for routine colonoscopy who were fasting for at least 1 day, were recruited (n=70).

Longitudinal study: Serial urine study: Patients presenting with bacteremic pneumococcal pneumonia (n=8) had samples collected within 4 days of receiving antibiotics in hospital, and several days post-admission after treatment with antibiotics.

Comparison to other lung infections: Patients with Legionella pneumophila (Legionnaires' disease and Pontiac Fever) (n=62), Mycobacterium tuberculosis (tuberculosis) (n=65), Staphylococcus aureus (n=27), Coxiella burnetii (n=15), Haemophilus influenzae (n=11), Mycoplasma pneumoniae (n=9), Escherichia coli (n=7), Enterococcus faecalis (n=3), Moraxella catarrhalis (n=4), Streptococcus viridans (n=2), Streptococcus anginosus (n=2), influenza A (n=16), picornavirus (n=12), respiratory syncycial virus (RSV) (n=11), parainfluenza viruses (n=8), coronavirus (n=6), human metapneumovirus (hMPV) (n=4), and hantavirus (n=1) were collected from Toronto, Edmonton and Australia.

Comparison to other lung diseases: Patients with asthma (n=31) or COPD exacerbations (n=44) were collected from the Emergency Department of the University of Alberta Hospital in Edmonton, Alberta, Canada. Patients were seen and assessed in the ED by treating physicians and a formal interview was completed with an ED chart review.

Blinded study: A set of urine samples was assembled from patients not part of the original learning set with the following: bacteremic pneumococcal pneumonia n=35; healthy n=42; non-infectious stress n=9; COPD=6; Asthma n=8; Tuberculosis n=24; Legionnaires' disease n=1; C. burnetii (Q-fever) n=20. The etiological diagnoses were unknown to the data analyzer and provided a diagnosis from metabolite concentrations before the code was broken.

Methods

Sample handling: Upon acquisition of urine samples, sodium azide was immediately added to a final concentration of approximately 0.02% to prevent bacterial growth. All urine samples were placed in a freezer and stored at −80° C. until NMR data acquisition. Urine samples were prepared by adding 70 μL of internal standard (Chenomx Inc., Edmonton, AB) (consisting of ˜5 mM DSS (sodium 2,2-dimethyl-2-silapentane-5-sulfonate), 100 mM Imidazole, 0.2% sodium azide in 99% D₂O) to 630 μL of urine. Using small amounts of NaOH or HCl, the sample was adjusted to pH 6.8±0.1. A 600 μL aliquot of prepared sample was placed in a 5 mm NMR tube (Wilmad, Buena, N.J.) and stored at 4° C. until ready for data acquisition.

NMR spectroscopy: All one-dimensional NMR spectra of urine samples were acquired using the first increment of the standard NOESY pulse sequence on a 4-channel Varian (Varian Inc., Palo Alto, Calif.) INOVA 600 MHz NMR spectrometer with triax-gradient 5 mm HCN probe. All spectra were recorded at 25° C. with a 12 ppm sweep width, 1 s recycle delay, 100 ms τₘᵢₓ, an acquisition time of 4 s, 4 dummy scans and 32 transients. ¹H decoupling of the water resonance was applied for 0.9 s of the recycle delay and during the 100 ms τₘᵢₓ.

Spectral processing: Processing of samples was accomplished by applying phase correction, followed by line-broadening of 0.5 Hz, zero-filling to 128 k data points, and reference deconvolution of spectral peaks to 1.3 Hz. This was done to ensure consistent lineshapes between spectra for fitting purposes. Baseline correction was also performed to ensure flat baselines for optimal analysis.

Spectral analysis: Analysis of these data was accomplished using the method of targeted profiling. An example of this is Chenomx NMR Suite 4.6 (Chenomx Inc., Edmonton, Canada), which compares the integral of a known reference signal (in this case DSS) with signals derived from a library of compounds (in this case 600 MHz) to determine concentration relative to the reference signal. Another example might be Datachord miner.

For each urine sample, the reference set of metabolites was assigned and quantified using the software. Briefly, each metabolite signature was compared with respect to lineshape, multiplicity, and spectral frequency to the database. Only those metabolites that produced clear signals that could be clearly subtracted from the original spectrum were analyzed.

Final metabolite concentrations were calculated from the raw output from Chenomx analysis by applying correction factors for internal standard dilution, and extra line-broadening of internal standard where applicable.

Statistical Analysis: For multivariate analysis, measured metabolite concentrations were subjected to log₁₀-transformation to account for the non-normal distributive nature of the data. NMR variables derived from targeted profiling were mean centered and unit variance scaling applied. PLS-DA (Partial Least Squares-Discriminant Analysis) was applied using various classifiers with SIMCA-P (version 11, Umetrics, Umeå, Sweden). PLS-DA is a supervised multivariate statistical analysis method that takes multidimensional data (for example 100 classified subjects×70 metabolites) and reduces it into coherent subsets that are independent of one another (for example 100 subjects (in 2 or more classes)×3 components). The primary purpose of PLS-DA is to reduce the number of variables (metabolites) and identify those variables that are inter-related and provide the greatest separation between the classes.

Box and whisker plots were performed using GraphPad Prism version 4.0c for Mac (GraphPad Software, San Diego, USA) on raw data. Indications of significance were based on results obtained from non-parametric two-tailed Mann-Whitney analysis (Wilcoxon rank sum test), with p<0.05 considered significant, or a p-value could be chosen based on Bonferroni correction methods.

Metabolites: The compounds measured were selected from one or more of the following metabolites: 1,3-dimethylurate, levoglucosan, 1-methylnicotinamide, metabolite 1 (which may be 2-aminobutyrate), 2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2 (which may be glycolate), metabolite 3 (which may be guanidoacetate), hippurate, histidine, hypoxanthine, isoleucine, lactate, leucine, lysine, mannitol, metabolite 4 (which may be methanol), metabolite 5 (which may be methylamine), metabolite 5 (which may be methylguanidine), N,N-dimethylglycine, O-acetylcarnitine, pantothenate, propylene glycol, pyroglutamate, pyruvate, quinolinate, serine, succinate, sucrose, metabolite 7 (which may be tartrate), taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

Results: Seventy metabolites were shown to differentiate patients testing positive for Streptococcus pneumoniae, Mycobacterium tuberculosis, Legionella pneumophila, Coxiella burnetii, Staphylococcus aureus, Mycoplasma pneumoniae, Haemophilus influenzae, and various viral forms of pneumonia including influenza A, parainfluenza, respiratory syncycial virus (RSV), picorna virus, corona virus, rhinovirus, human metapneumovirus (hMPV), and hantavirus from each other and otherwise healthy subjects. All groups included subjects with diabetes and heart disease. Removal of these patients from the population did not affect the plots. Moreover, in the pneumococcal group, patients as young as 6 days and in all groups patients as old as 96 were part of the populations.

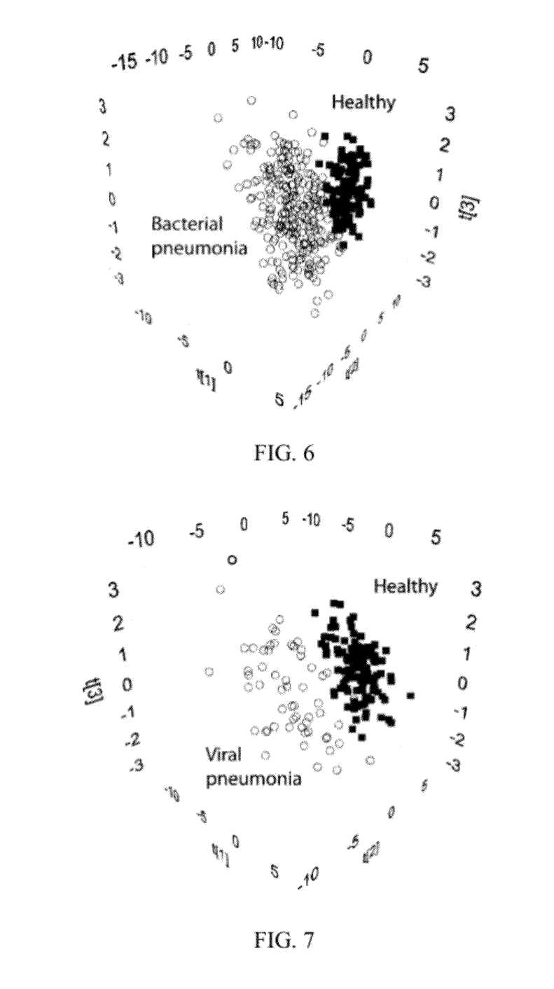

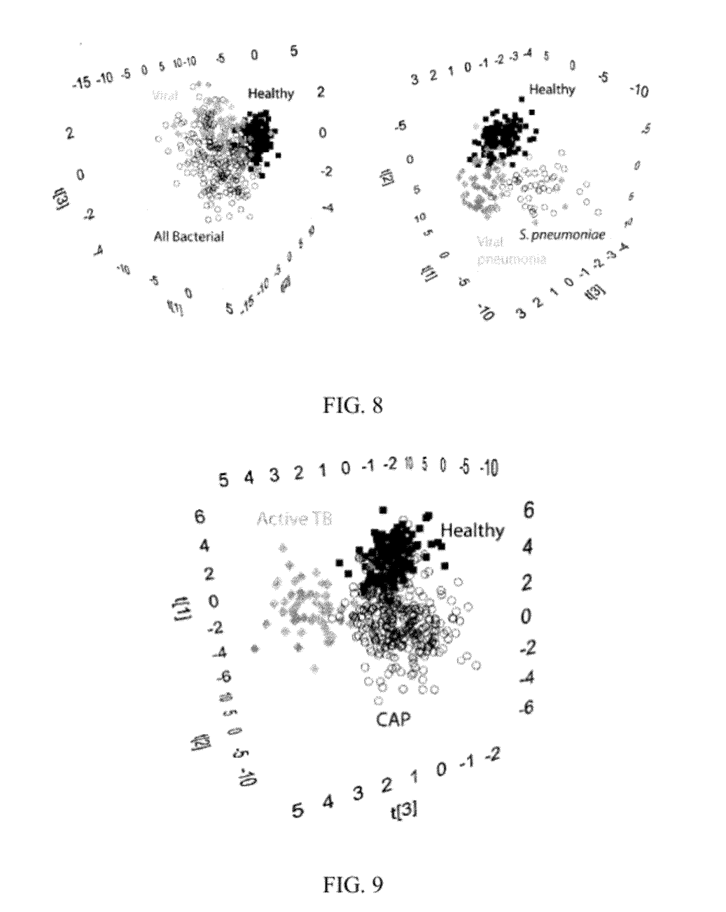

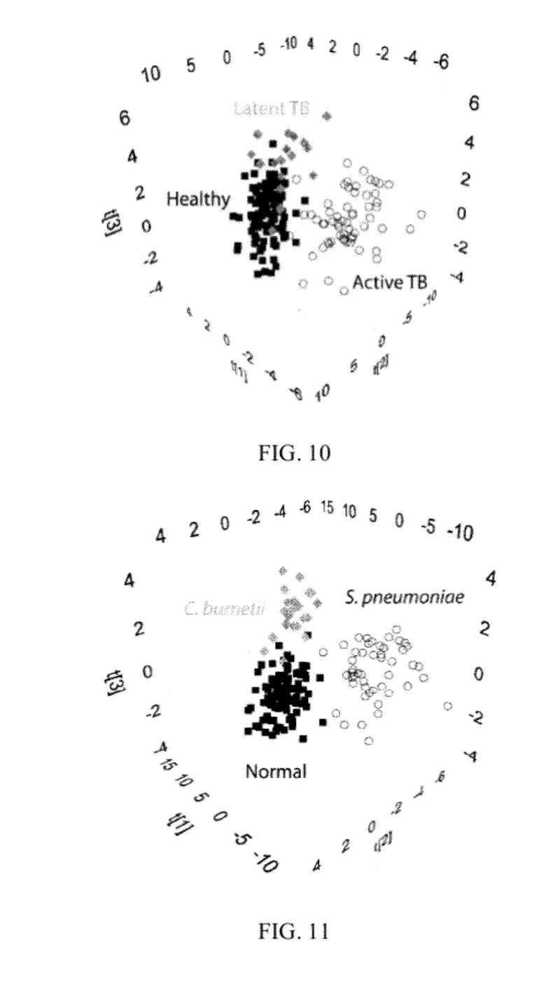

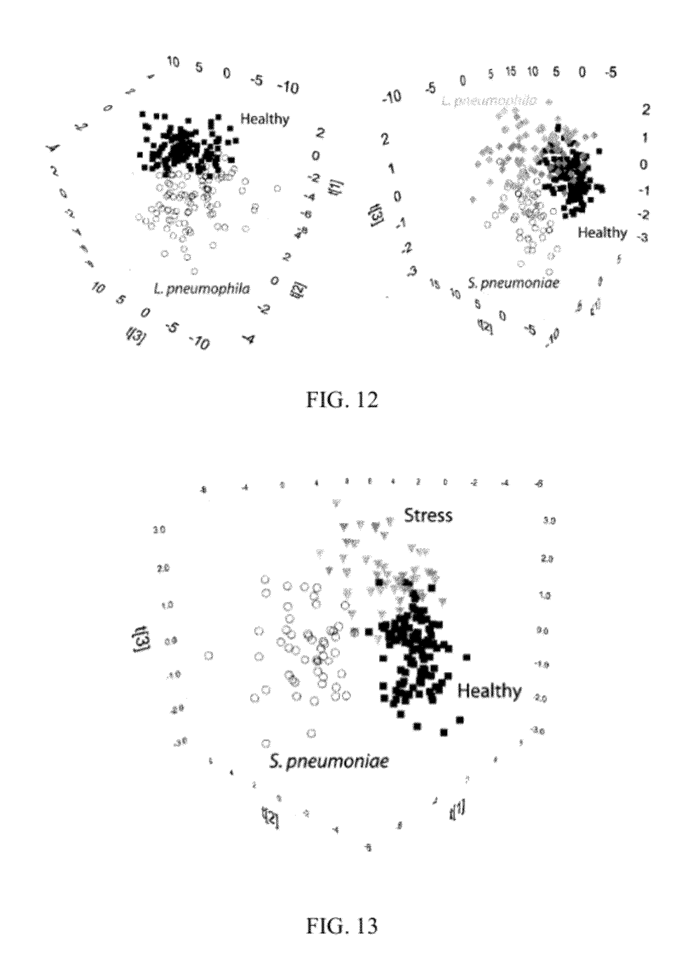

FIGS. 6 through 12 depict the urinary metabolite profiles derived in the various tests, and show a clear distinction between the groups being compared. FIG. 6 shows urinary metabolite profiles derived from subjects having either bacterial pneumonia (from pathogens such as Streptococcus pneumoniae, Staphylococcus aureus, Haemophilus influenzae, Mycoplasma pneumoniae, Escherichia coli, and others) or those without pneumonia. PLS-DA model illustrates the difference between “Healthy” (▪) versus those with bacterial pneumonia (◯). FIG. 7 shows urinary metabolite profiles derived from subjects having either viral pneumonia (caused from pathogens such as influenza A, respiratory syncycial virus (RSV), parainfluenza, picorna virus, corona virus, rhinovirus, and human metapneumovirus (hMPV)) or those without pneumonia. PLS-DA model illustrates the difference between “Healthy” (▪) versus those with viral pneumonia (♦). FIG. 8 compares urinary metabolite profiles derived from subjects with bacterial or S. pneumoniae pneumonia with healthy subjects and subjects with viral pneumonia. PLS-DA model shows “Healthy” (▪), bacterial or S. pneumoniae pneumonia (◯) or viral pneumonia (♦). FIG. 9 is a comparison of urinary metabolite profiles derived from subjects with active Mycobacterium tuberculosis infection (♦) versus healthy (▪) and all other forms of community acquired pneumonia (◯). FIG. 10 is a comparison of active M. tuberculosis (◯) with latent M. tuberculosis (♦) and a “Healthy” population (▪). FIG. 11 compares the urinary metabolite profiles derived from individuals with Coxiella burnetii infection (Q-fever) (♦) with S. pneumoniae (◯) and normal, “healthy” individuals (▪). FIG. 12 compares the urinary metabolite profiles derived from individuals with Legionella pneumophila (◯ or ♦) with normal (▪) and S. pneumoniae (◯).

Since most patients with pneumococcal pneumonia experience metabolic stress from infection, it was investigated as to whether some of the observed responses might be due to stress. A group of patients with non-infectious metabolic stress, defined as anyone presenting to the emergency room with a condition other than an infectious disease, consisted of fractures (31%), myocardial infarcts (24%), lacerations (24%), congestive heart failure (21%), and others (1%). Comparison between the normal, healthy group and the stress group revealed class distinction. Comparison of the stressed group with the pneumococcal and normal groups together revealed that the stressed group was distinct from both, as shown in FIG. 13.

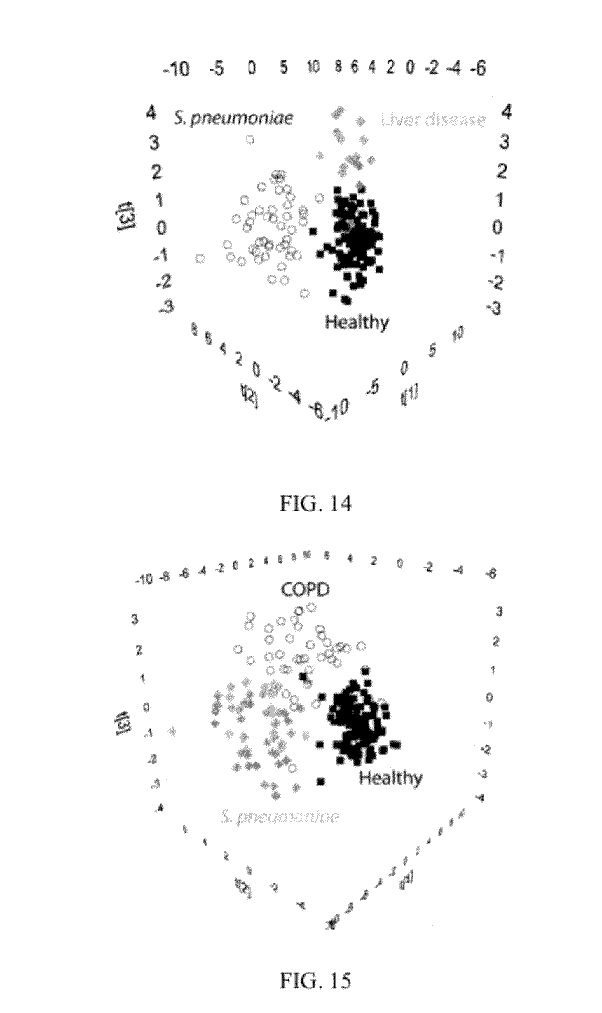

Since some metabolites that were observed to be perturbed upon infection have been implicated in hepatotoxicity, it was investigated as to whether individuals with liver dysfunction would have a similar profile. Urine was collected from 16 individuals with hepatitis (n=12) or cirrhosis (n=4) and compared with the pneumococcal and normal groups, as shown in FIG. 14. Clear distinction was seen in a PCA plot of healthy versus pneumococcal pneumonia versus those with liver dysfunction.

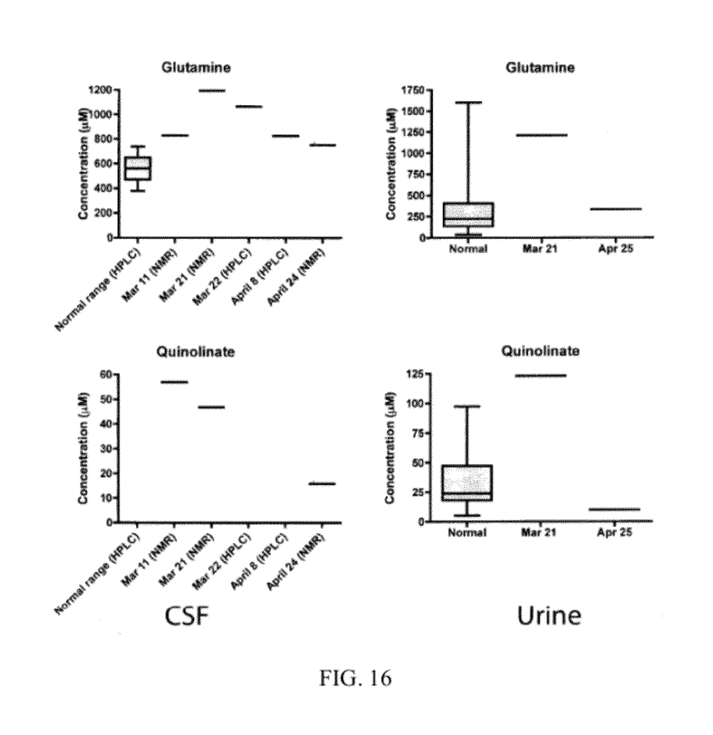

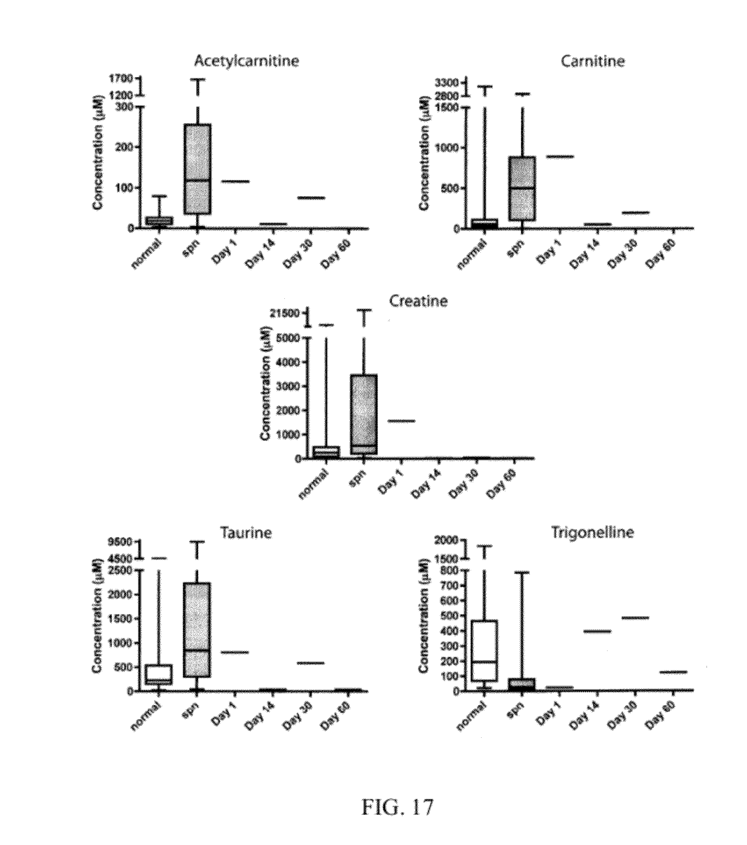

A comparison of urine metabolite profiles of pulmonary infectious diseases to other types of pulmonary diseases, such as COPD resulted in a distinction between these groups, as shown in FIG. 15.

The numerical results are summarized in the tables shown in Tables 1 through 6 below:

TABLE 1
S. pneumoniae Biomarkers from Urine: Wilcoxon's
Rank Sum Test S. pneumoniae pneumonia v. Controls

| | | Increase (+) or | |
|---|---|---|---|
| | | Decrease (−) in | % change in |
| | | S. pneumoniae | S. pneumoniae |
| Compound | p-value | pneumonia | pneumonia |
| Levoglucosan | P < 0.0001 | − | 62 |
| Metabolite 1 | P < 0.0001 | + | 357 |
| 2-Oxoglutarate | P < 0.0001 | + | 135 |
| 3-Hydroxybutyrate | P < 0.0001 | + | 315 |
| Acetate | P < 0.0001 | + | 168 |
| Acetone | P < 0.0001 | + | 267 |
| Adipate | P < 0.0001 | + | 89 |
| Alanine | P < 0.0001 | + | 119 |
| Asparagine | P < 0.0001 | + | 68 |
| Carnitine | P < 0.0001 | + | 925 |
| Citrate | P < 0.0001 | − | 71 |
| Dimethylamine | P < 0.0001 | + | 71 |
| Fumarate | P < 0.0001 | + | 248 |
| Glucose | P < 0.0001 | + | 259 |
| Metabolite 3 | P < 0.0001 | − | 51 |
| Hypoxanthine | P < 0.0001 | + | 147 |
| Isoleucine | P < 0.0001 | + | 114 |
| Lactate | P < 0.0001 | + | 116 |
| Leucine | P < 0.0001 | + | 155 |
| Lysine | P < 0.0001 | + | 87 |
| Metabolite 6 | P < 0.0001 | − | 59 |
| Acetylcarnitine | P < 0.0001 | + | 705 |
| Metabolite 7 | P < 0.0001 | + | 112 |
| Quinolinate | P < 0.0001 | + | 108 |
| Taurine | P < 0.0001 | + | 291 |
| Trigonelline | P < 0.0001 | − | 86 |
| Tryptophan | P < 0.0001 | + | 125 |
| Tyrosine | P < 0.0001 | + | 94 |
| Valine | P < 0.0001 | + | 127 |
| myo-Inositol | P < 0.0001 | + | 437 |
| Serine | 0.0001 | + | 58 |
| Threonine | 0.0001 | + | 91 |
| Fucose | 0.0003 | + | 98 |
| 1-Methylnicotinamide | 0.0004 | − | 49 |
| Creatine | 0.0004 | + | 105 |
| π-Methylhistidine | 0.0008 | − | 65 |
| Pyroglutamate | 0.0014 | + | 26 |
| Metabolite 4 | 0.0025 | − | 27 |
| cis-Aconitate | 0.006 | + | 43 |
| τ-Methylhistidine | 0.00 8 | + | 102 |
| Xylose | 0 0144 | + | 34 |
| Uracil | 0.0162 | − | 24 |
| Urea | 0.0189 | + | 19 |
| Betaine | 0.0198 | + | 45 |
| Metabolite 2 | 0. 217 | − | 39 |
| Allantoin | 0.0224 | + | 30 |
| Hippurate | 0.0259 | − | 32 |
| Formate | 0.0374 | − | 23 |
| 3-Amino sobutyrate | 0.0426 | + | |
| 4-HydroxyphenylAcet te | 0.0702 | + | 15 |
| N,N-Dimethylglycine | 0.0924 | − | 26 |
| Succinate | 0.1003 | − | 27 |
| Sucrose | 0.193 | + | 34 |
| Histidine | 0.1992 | + | 48 |
| Metabolite 5 | 0.2471 | + | 8 |
| Propylene glycol | 0.3017 | + | 85 |
| trans-Aconitate | 0.3389 | + | 18 |
| Glutamine | 0.348 | + | 28 |
| Metabolite 8 | 0.3572 | − | 23 |
| 3-Indoxylsulfate | 0.3858 | + | 18 |
| Creatinine | 0.4097 | + | 10 |
| 3-Hydroxyisovalerate | 0.4219 | + | 17 |
| Glycine | 0.4449 | − | 11 |
| Mannitol | 0.4885 | + | 11 |
| 2-Hydroxyisobutyrate | 0.4975 | − | 9 |
| Ethanolamine | 0.673 | − | 2 |
| Trimethylamine-N-oxide | 0.81 | + | 3 |

TABLE 2
S. pneumoniae Biomarkers from Urine: Wilcoxon's Rank
Sum Test S. pneumoniae pneumonia v. viral pneumonia

| | | Increase (+) or | |
|---|---|---|---|
| | | Decrease (−) in | % change in |
| | | S. pneumoniae | S. pneumoniae |
| Compound | p-value | pneumonia | pneumonia |
| Metabolite 1 | P < 0.0001 | + | 210 |
| 2-Oxoglutarate | P < 0.0001 | + | 279 |
| 3-Hydroxybutyrate | P < 0.0001 | + | 326 |
| Acetate | P < 0.0001 | + | 148 |
| Alanine | P < 0.0001 | + | 217 |
| Asparagine | P < 0.0001 | + | 95 |
| Betaine | P < 0.0001 | + | 135 |
| Carnitine | P < 0.0001 | + | 455 |
| Creatine | P < 0.0001 | + | 295 |
| Dimethylamine | P < 0.0001 | + | 99 |
| Fumarate | P < 0.0001 | + | 258 |
| Glucose | P < 0.0001 | + | 169 |
| Isoleucine | P < 0.0001 | + | 182 |
| Lactate | P < 0.0001 | + | 226 |
| Leucine | P < 0.0001 | + | 242 |
| Acetylcarnitine | P < 0.0001 | + | 429 |
| Pyroglutamate | P < 0.0001 | + | 98 |
| Serine | P < 0.0001 | + | 96 |
| Threonine | P < 0.0001 | + | 186 |
| Tryptophan | P < 0.0001 | + | 166 |
| Tyrosine | P < 0.0001 | + | 126 |
| Urea | P < 0.0001 | + | 69 |
| Valine | P < 0.0001 | + | 201 |
| myo-Inositol | P < 0.0001 | + | 267 |
| Metabolite 5 | 0.0001 | + | 78 |
| 4-HydroxyphenylAcetate | 0.0001 | + | 93 |
| Hypoxanthine | 0.0001 | + | 111 |
| Propylene glycol | 0.0001 | + | 229 |
| Lysine | 0.0002 | + | 94 |
| cis-Aconitate | 0.0002 | + | 144 |
| Allantoin | 0.0003 | + | 75 |
| Metabolite 7 | 0.0004 | + | 95 |
| Adipate | 0.0006 | + | 71 |
| τ-Methylhistidine | 0.0024 | + | 173 |
| Creatinine | 0.0026 | + | 56 |
| Glutamine | 0.0034 | + | 75 |
| Fucose | 0.0035 | + | 118 |
| Ethanolamine | 0.004 | + | 59 |
| Acetone | 0.005 | + | 202 |
| Taurine | 0.0063 | + | 128 |
| Succinate | 0.0066 | + | 57 |
| Glycine | 0.008 | + | 89 |
| Metabolite 4 | 0.0093 | + | 26 |
| Hippurate | 0.0106 | + | 80 |
| Mannitol | 0.0134 | + | 89 |
| 3-Hydroxyisovalerate | 0.0142 | + | 61 |
| 3-Indoxylsulfate | 0.0147 | + | 65 |
| Metabolite 3 | 0.0191 | + | 23 |
| Metabolite 2 | 0.0234 | + | 45 |
| 2-Hydroxyisobutyrate | 0.03 | + | 31 |
| Formate | 0.0305 | + | 45 |
| 3-Aminoisobutyrate | 0.0358 | + | 101 |
| Trimethylamine-N-oxide | 0.0418 | + | 41 |
| Quinolinate | 0.0431 | + | 115 |
| Metabolite 8 | 0.0445 | + | 36 |
| Histidine | 0.0525 | + | 105 |
| Uracil | 0.0549 | + | 37 |
| trans-Aconitate | 0.1382 | + | 65 |
| Citrate | 0.2205 | + | 37 |
| Trigonelline | 0.2205 | − | 39 |
| Xylose | 0.2229 | + | 36 |
| N,N-Dimethylglycine | 0.2785 | + | 11 |
| Sucrose | 0.3204 | + | 22 |
| 1-Methylnicotinamide | 0.3235 | + | 29 |
| Levoglucosan | 0.6642 | − | 1 |
| Metabolite 6 | 0.8495 | + | 3 |
| π-Methylhistidine | 0.8799 | − | 19 |

TABLE 3
S. pneumoniae Biomarkers from Urine: Wilcoxon's Rank
Sum Test S. pneumoniae pneumonia v. bacterial pneumonia

| | | Increase (+) or | |
|---|---|---|---|
| | | Decrease (−) in | % change in |
| | | S. pneumoniae | S. pneumoniae |
| Compound | p-value | pneumonia | pneumonia |
| Metabolite 1 | P < 0.0001 | + | 260 |
| 2-Oxoglutarate | P < 0.0001 | + | 190 |
| 3-Hydroxybutyrate | P < 0.0001 | + | 336 |
| Acetate | P < 0.0001 | + | 414 |
| Allantoin | P < 0.0001 | + | 193 |
| Creatine | P < 0.0001 | + | 791 |
| Creatinine | P < 0.0001 | + | 176 |
| Dimethylamine | P < 0.0001 | + | 159 |
| Fumarate | P < 0.0001 | + | 208 |
| Hippurate | P < 0.0001 | + | 270 |
| Hypoxanthine | P < 0.0001 | + | 215 |
| Isoleucine | P < 0.0001 | + | 182 |
| Lactate | P < 0.0001 | + | 178 |
| Leucine | P < 0.0001 | + | 189 |
| Pyroglutamate | P < 0.0001 | + | 156 |
| Succinate | P < 0.0001 | + | 292 |
| Trimethylamine-N-oxide | P < 0.0001 | + | 256 |
| Urea | P < 0.0001 | + | 143 |
| Valine | P < 0.0001 | + | 228 |
| cis-Aconitate | P < 0.0001 | + | 169 |
| Alanine | 0.0001 | + | 173 |
| Acetylcarnitine | 0.0001 | + | 319 |
| Acetone | 0.0002 | + | 233 |
| Lysine | 0.0002 | + | 134 |
| Metabolite 4 | 0.0002 | + | 66 |
| Metabolite 7 | 0.0002 | + | 159 |
| Uracil | 0.0002 | + | 192 |
| Betaine | 0.0003 | + | 154 |
| Metabolite 5 | 0.0003 | + | 141 |
| Tryptophan | 0.0003 | + | 171 |
| Carnitine | 0.0004 | + | 305 |
| Xylose | 0.0004 | + | 128 |
| 3-Aminoisobutyrate | 0.0005 | + | 140 |
| Glucose | 0.0005 | + | 136 |
| Metabolite 3 | 0.0005 | + | 90 |
| Taurine | 0.0005 | + | 341 |
| Tyrosine | 0.0005 | + | 177 |
| 3-Indoxylsulfate | 0.0007 | + | 150 |
| 2-Hydroxyisobutyrate | 0.0008 | + | 102 |
| Metabolite 2 | 0.001 | + | 45 |
| 4-HydroxyphenylAcetate | 0.0013 | + | 84 |
| τ-Methylhistidine | 0.0018 | + | 321 |
| Fucose | 0.0021 | + | 93 |
| myo-Inositol | 0.0031 | + | 117 |
| Adipate | 0.0034 | + | 50 |
| Mannitol | 0.0045 | + | 119 |
| Metabolite 8 | 0.0066 | + | 113 |
| Ethanolamine | 0.0082 | + | 75 |
| trans-Aconitate | 0.0105 | + | 126 |
| Quinolinate | 0.0115 | + | 86 |
| Formate | 0.0143 | + | 58 |
| 1-Methylnicotinamide | 0.0255 | + | 77 |
| Serine | 0.0262 | + | 61 |
| Levoglucosan | 0.0333 | + | 104 |
| Asparagine | 0.0373 | + | 38 |
| 3-Hydroxyisovalerate | 0.0456 | + | 26 |
| π-Methylhistidine | 0.1113 | + | 109 |
| Threonine | 0.122 | + | 55 |
| Trigonelline | 0.1526 | + | 53 |
| Histidine | 0.1617 | + | 84 |
| Glutamine | 0.2 | + | 34 |
| N,N-Dimethylglycine | 0.2805 | + | 34 |
| Citrate | 0.3048 | + | 77 |
| Glycine | 0.3189 | + | 18 |
| Propylene glycol | 0.5993 | + | 44 |
| Metabolite 6 | 0.8871 | + | 26 |
| Sucrose | 0.98 | − | 28 |

TABLE 4
S. pneumonia Biomarkers from Urine: Wilcoxon's Rank
Sum Test S. pneumonia pneumonia v. Coxiella burnetti

| | | Increase (+) or | |
|---|---|---|---|
| | | Decrease (−) in | % change in |
| | | S. neumonia | S. neumonia |
| Compound | p-value | pneumonia | pneumonia |
| Metabolite 1 | P < 0.0001 | + | 636 |
| 3-Aminoisobutyrate | P < 0.0001 | + | 373 |
| 3-Hydroxybutyrate | P < 0.0001 | + | 1106 |
| Acetate | P < 0.0001 | + | 1400 |
| Acetone | P < 0.0001 | + | 942 |
| Adipate | P < 0.0001 | + | 285 |
| Alanine | P < 0.0001 | + | 367 |
| Allantoin | P < 0.0001 | + | 206 |
| Asparagine | P < 0.0001 | + | 322 |
| Betaine | P < 0.0001 | + | 308 |
| Carnitine | P < 0.0001 | + | 4066 |
| Mannitol | 0.0023 | + | 261 |
| Trigonelline | 0.003 | − | 82 |
| Glutamine | 0.0049 | + | 79 |
| τ-Methylhistidine | 0.0087 | + | 178 |
| Ethanolamine | 0.0101 | + | 87 |
| Glycine | 0.0104 | + | 125 |
| Quinolinate | 0.0112 | + | 101 |
| Histidine | 0.0144 | + | 145 |
| Metabolite 2 | 0.016 | + | 87 |
| 2-Hydroxyisobutyrate | 0.0165 | + | 88 |
| cis-Aconitate | 0.0196 | + | 87 |
| N,N-Dimethylglycine | 0.0232 | + | 29 |
| Metabolite 8 | 0.0248 | + | 73 |
| Uracil | 0.0464 | + | 67 |
| 4-HydroxyphenylAcetate | 0.0478 | + | 113 |
| Hippurate | 0.0639 | + | 49 |
| Metabolite 3 | 0.0735 | + | 63 |
| Trimethylamine-N-oxide | 0.1511 | + | 23 |
| Levoglucosan | 0.1905 | − | 51 |
| π-Methylhistidine | 0.3591 | − | 41 |
| Metabolite 6 | 0.4985 | + | 38 |
| 1-Methylnicotinamide | 0.7518 | − | 13 |
| Citrate | 0.7954 | + | 10 |

TABLE 5
S. pneumoniae Biomarkers from Urine: Wilcoxon's Rank Sum
Test S. pneumoniae pneumonia v. Legionella pneumophila

| | | Increase (+) or | |
|---|---|---|---|
| | | Decrease (−) in | % change in |
| | | S. pneumoniae | S. pneumoniae |
| Compound | p-value | pneumonia | pneumonia |
| 2-Oxoglutarate | P < 0.0001 | + | 88 |
| Asparagine | P < 0.0001 | + | 89 |
| Carnitine | P < 0.0001 | + | 637 |
| Acetylcarnitine | P < 0.0001 | + | 392 |
| Threonine | P < 0.0001 | + | 100 |
| Tryptophan | P < 0.0001 | + | 118 |
| cis-Aconitate | P < 0.0001 | + | 219 |
| Tyrosine | 0.0001 | + | 83 |
| 3-Hydroxybutyrate | 0.0002 | + | 150 |
| Fumarate | 0.0002 | + | 134 |
| myo-Inositol | 0.0007 | + | 165 |
| Glutamine | 0.001 | + | 95 |
| Valine | 0.0015 | + | 69 |
| Metabolite 1 | 0.0016 | + | 152 |
| Hypoxanthine | 0.0016 | + | 78 |
| Pyroglutamate | 0.0018 | + | 28 |
| Serine | 0.002 | + | 35 |
| Urea | 0.0024 | + | 49 |
| Alanine | 0.0026 | + | 57 |
| Histidine | 0.0029 | + | 139 |
| τ-Methylhistidine | 0.0034 | + | 83 |
| Glucose | 0.0036 | + | 87 |
| Acetone | 0.0068 | + | 136 |
| Fucose | 0.0071 | + | 51 |
| Metabolite 8 | 0.0073 | + | 35 |
| Trimethylamine-N-oxide | 0.0119 | + | 51 |
| Trigonelline | 0.0146 | − | 48 |
| Lactate | 0.0153 | + | 51 |
| Metabolite 7 | 0.0155 | + | 68 |
| Acetate | 0.0163 | + | 72 |
| Taurine | 0.0168 | + | 194 |
| Lysine | 0.035 | + | 36 |
| Propylene glycol | 0.0374 | + | 89 |
| Betaine | 0.0391 | + | 25 |
| 4-HydroxyphenylAcetate | 0.045 | + | 21 |
| Xylose | 0.0511 | + | 47 |
| Metabolite 4 | 0.0527 | − | 19 |
| 3-Hydroxyisovalerate | 0.1088 | + | 53 |
| Mannitol | 0.1213 | + | 15 |
| 1-Methylnicotinamide | 0.1234 | − | 35 |
| Leucine | 0.1325 | + | 37 |
| Adipate | 0.1372 | + | 4 |
| Succinate | 0.1586 | + | 28 |
| trans-Aconitate | 0.164 | + | 24 |
| Isoleucine | 0.187 | + | 29 |
| Allantoin | 0.19 | + | 8 |
| 3-Aminoisobutyrate | 0.1962 | + | 17 |
| Dimethylamine | 0.2041 | + | 16 |
| Metabolite 3 | 0.2207 | − | 23 |
| Levoglucosan | 0.2328 | − | 27 |
| Metabolite 5 | 0.3026 | + | 25 |
| Uracil | 0.3112 | + | 20 |
| Ethanolamine | 0.331 | + | 26 |
| π-Methylhistidine | 0.3355 | + | 25 |
| Sucrose | 0.3802 | + | 17 |
| Quinolinate | 0.3901 | + | 25 |
| Formate | 0.3951 | + | 5 |
| Citrate | 0.4027 | − | 29 |
| 2-Hydroxyisobutyrate | 0.4052 | − | 24 |
| Creatine | 0.4259 | − | 6 |
| Hippurate | 0.4635 | + | 5 |
| Metabolite 6 | 0.544 | − | 21 |
| 3-Indoxylsulfate | 0.6309 | + | 4 |
| Glycine | 0.66 | + | 7 |
| Creatinine | 0.7676 | + | 8 |
| N,N-Dimethylglycine | 0.9156 | − | 13 |
| Metabolite 2 | 0.955 | + | 52 |

TABLE 6
S. pneumonia Biomarkers from Urine: Wilcoxon's Rank Sum
Test S. pneumonia pneumonia v. Mycobacterium tuberculosis

| | | Increase (+) or | |
|---|---|---|---|
| | | Decrease (−) in | % change in |
| | | S. neumonia | S. neumonia |
| Compound | p-value | pneumonia | pneumonia |
| 1-Methylnicotinamide | P < 0.0001 | − | 76 |
| 3-Hydroxybutyrate | P < 0.0001 | + | 266 |
| Adipate | P < 0.0001 | + | 140 |
| Alanine | P < 0.0001 | + | 186 |
| Asparagine | P < 0.0001 | + | 85 |
| Carnitine | P < 0.0001 | + | 438 |
| Creatine | P < 0.0001 | + | 499 |
| Fumarate | P < 0.0001 | + | 199 |
| Glucose | P < 0.0001 | + | 154 |
| Hypoxanthine | P < 0.0001 | + | 154 |
| Isoleucine | P < 0.0001 | + | 116 |
| Lactate | P < 0.0001 | + | 177 |
| Lysine | P < 0.0001 | + | 83 |
| Acetylcarnitine | P < 0.0001 | + | 292 |
| Pyroglutamate | P < 0.0001 | + | 110 |
| Quinolinate | P < 0.0001 | − | 76 |
| Taurine | P < 0.0001 | + | 329 |
| Threonine | P < 0.0001 | + | 112 |
| Tryptophan | P < 0.0001 | + | 177 |
| Tyrosine | P < 0.0001 | + | 109 |
| Valine | P < 0.0001 | + | 137 |
| Acetate | 0.0001 | + | 122 |
| Hippurate | 0.0001 | + | 160 |
| Creatinine | 0.0002 | + | 70 |
| Dimethylamine | 0.0002 | + | 74 |
| Urea | 0.0004 | + | 47 |
| Glycine | 0.0005 | + | 105 |
| τ-Methylhistidine | 0.0006 | + | 118 |
| 2-Oxoglutarate | 0.001 | + | 70 |
| Serine | 0.0012 | + | 66 |
| Trigonelline | 0.0013 | − | 59 |
| Leucine | 0.0014 | + | 94 |
| Acetone | 0.0015 | + | 106 |
| Trimethylamine-N-oxide | 0.0019 | + | 90 |
| myo-Inositol | 0.0026 | + | 126 |
| Metabolite 1 | 0.003 | + | 301 |
| 2-Hydroxyisobutyrate | 0.0036 | + | 49 |
| Betaine | 0.0059 | + | 70 |
| trans-Aconitate | 0.0168 | + | 62 |
| Mannitol | 0.031 | + | 44 |
| Glutamine | 0.0389 | + | 34 |
| π-Methylhistidine | 0.0394 | − | 46 |
| Metabolite 2 | 0.0475 | − | 2 |
| Allantoin | 0.0515 | + | 35 |
| Histidine | 0.0578 | + | 98 |
| cis-Aconitate | 0.0656 | + | 64 |
| Uracil | 0.069 | + | 53 |
| Sucrose | 0.1083 | + | 33 |
| Metabolite 4 | 0.1223 | − | 18 |
| Metabolite 3 | 0.1322 | + | 19 |
| Metabolite 7 | 0.1427 | + | 34 |
| Metabolite 5 | 0.1443 | − | 15 |
| 3-Indoxylsulfate | 0.157 | + | 41 |
| Succinate | 0.205 | + | 30 |
| Metabolite 8 | 0.2336 | + | 16 |
| Formate | 0.3117 | − | 18 |
| Ethanolamine | 0.3198 | + | 20 |
| 4-HydroxyphenylAcetate | 0.3421 | − | 4 |
| Xylose | 0.3421 | − | 9 |
| N,N-Dimethylglycine | 0.503 | − | 8 |
| Propylene glycol | 0.521 | − | 30 |
| Metabolite 6 | 0.664 | − | 10 |
| Levoglucosan | 0.7052 | − | 20 |
| Fucose | 0.7177 | + | 24 |
| 3-Aminoisobutyrate | 0.7814 | + | 25 |
| 3-Hydroxyisovalerate | 0.8161 | − | 7 |
| Citrate | 0.8908 | − | 25 |

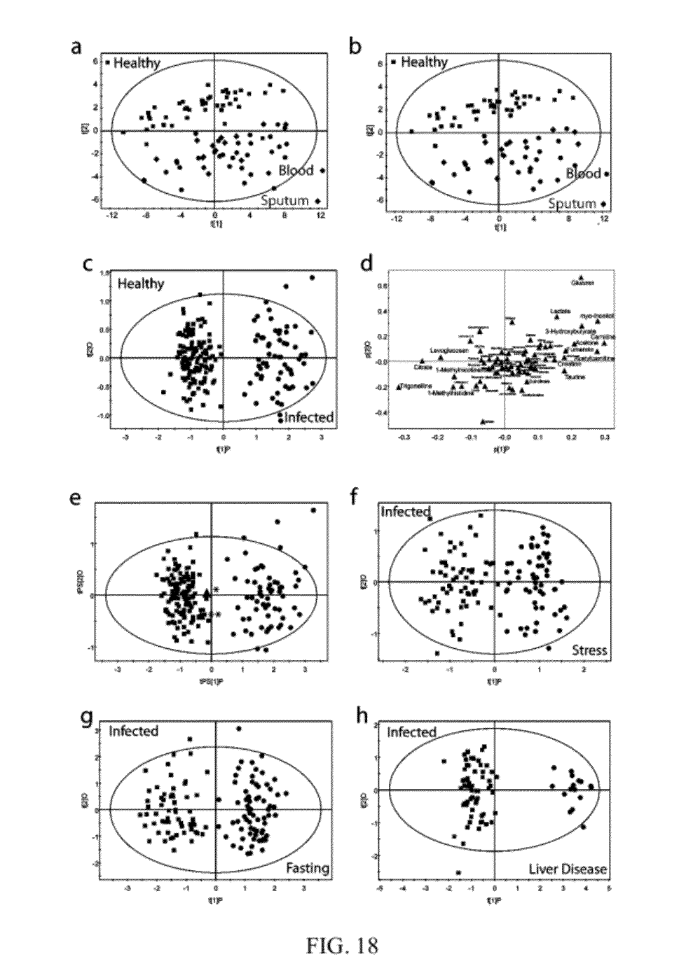

Another analysis based on the same data is represented in FIG. 18 through 24. Comparison of 61 metabolite concentrations measured in urine from age- and gender-matched S. pneumoniae infected (n=47) and non-infected (n=47) subjects revealed complete class distinction (R²=0.582; Q²=0.364) using principal components analysis (PCA) (FIG. 18a). No distinction was observed between those with bacteremia (bacteria present in the blood) (n=32) and those with S. pneumoniae-positive sputum or respiratory secretions obtained via endotracheal tube culture (n=15) (see FIG. 18a). Removal of eight individuals with diabetes from the pneumococcal group, and three diabetics from the “healthy” group did not affect the distribution of the PCA plots (R²=0.508; Q²=0.376) (see FIG. 18b). The three pediatric patients with pneumococcal pneumonia were equally distributed within the S. pneumoniae cohort on the PCA plot. Application of orthogonal partial least squares-discriminant analysis (OPLS-DA) to the entire dataset to optimize inter-group variation resulted in clear distinction between pneumococcal patients and “healthy” subjects (see FIG. 18c). Severity of disease and symptoms did not appear to affect the metabolite pattern in any discernable way. Both cohorts included subjects with a variety of co-morbidities including asthma and chronic obstructive pulmonary disease (COPD). The model parameters for the explained variation, R², and the predictive capability, Q², were significantly high (R²=0.902; Q²=0.820), indicating an excellent model.

Out of a total of 61 quantified metabolites, 6 significantly decreased in concentration, and 27 significantly increased when comparing subjects infected with S. pneumoniae to uninfected subjects, as shown in Table 7 below. Of the 6 metabolites that decreased significantly, two are TCA cycle intermediates (citrate, and succinate), and one is involved with nicotinamide metabolistm (1-methylnicotinamide). Other metabolites that decreased in concentration are associated with food intake (levoglucosan, and trigonelline) and protein catabolism (1-methylhistidine). Metabolites that increased in concentration included amino acids (alanine, asparagine, isoleucine, leucine, lysine, serine, threonine, tryptophan, tyrosine, and valine), those involved with glycolysis (glucose, lactate), fatty acid oxidation (3-hydroxybutyrate, acetone, carnitine, acetylcarnitine), inflammation (hypoxanthine, fucose), osmolytes (myo-inositol, taurine), acetate, quinolinate, adipate, dimethylamine, and creatine. Of interest, the TCA cycle intermediates 2-oxoglutarate and fumarate appeared to increase upon pneumococcal infection. Metabolites that did not change with pneumococcal infection included creatinine, some amino acids (glycine, glutamine, histidine and pyroglutamate), 3-methylhistidine, aconitate (trans and cis), metabolites related to gut microflora (3-indoxylsulfate, 4-hydroxyphenylacetate, hippurate, formate and TMAO (trimethylamine-N-oxide)), dietary metabolites (mannitol, propylene glycol, sucrose, tartrate), and others.

TABLE 7
Metabolite changes in human urine induced by S. pneumonia lung
infection when compared to healthy.

| | % | | |
|---|---|---|---|
| Metabolite¹ | Change² | p-value³ | Rank⁴ |
| Carnitine | +925 | <0.0001 | 2 |
| Acetylcarnitine | +705 | <0.0001 | 4 |
| myo-Inositol | +437 | <0.0001 | 3 |
| 3-Hydroxybutyrate | +315 | <0.0001 | 7 |
| Taurine | +291 | <0.0001 | 13 |
| Acetone | +267 | <0.0001 | 8 |
| Glucose | +259 | <0.0001 | 6 |
| Fumarate | +248 | <0.0001 | 9 |
| Acetate | +168 | <0.0001 | 19 |
| Leucine | +155 | <0.0001 | 16 |
| Hypoxanthine | +147 | <0.0001 | 25 |
| 2-Oxoglutarate | +135 | <0.0001 | 26 |
| Valine | +127 | <0.0001 | 21 |
| Tryptophan | +125 | <0.0001 | 27 |
| Alanine | +119 | <0.0001 | 29 |
| Lactate | +116 | <0.0001 | 15 |
| Isoleucine | +114 | <0.0001 | 23 |
| Quinolinate | +108 | <0.0001 | 35 |
| Creatine | +105 | 0.0004 | 17 |
| Fucose | +98 | 0.0003 | 44 |
| Tyrosine | +94 | <0.0001 | 37 |
| Threonine | +91 | <0.0001 | 34 |
| Adipate | +89 | <0.0001 | 18 |
| Lysine | +87 | <0.0001 | 26 |
| Dimethylamine | +71 | <0.0001 | 49 |
| Asparagine | +68 | <0.0001 | 31 |
| Serine | +58 | 0.0001 | 42 |
| 1-Methylnicotinamide | 49 | 0.0004 | 12 |
| Succinate | 59 | <0.0001 | 40 |
| Levoglucosan | 62 | <0.0001 | 10 |
| 1-Methylhistidine | 65 | 0.0008 | 14 |
| Citrate | 71 | <0.0001 | 5 |
| Trigonelline | 86 | <0.0001 | 1 |

¹Metabolites ranked according to % Change;
²Change calculated as difference in median concentration between S. neumonia infected and healthy;
³Significance is shown after application of Bonferroni correction;
⁴Variable rank was determined from the OPLS-DA variable importance to projection (VIP) for the model S. neumonia versus the non-infected, “healthy” population.

PLS-DA class prediction was performed on two patients with S. pneumoniae isolated from sputum, but normal chest radiographs and otherwise no evidence of infection. Both patients were predicted to be in the non-infected class as opposed to pneumococcal pneumonia class (see FIG. 18d). Presumably these two patients were colonized with S. pneumoniae.

Since most patients with pneumococcal pneumonia experience metabolic stress due to infection, we investigated whether some of the observed responses could be explained by the stress brought on by conditions other than infection. A group (n=55) of patients with non-infectious metabolic stress, defined as anyone presenting to the emergency department (ED) with a condition other than an infectious disease, consisted of fractures (31%), myocardial infarcts (24%), lacerations (24%), and congestive heart failure (21%). Comparison between the normal, healthy group and the stress group revealed good class distinction (FIG. 18e) with corresponding R² of 0.828 and Q² of 0.655. One sample (from a 70 year-old female with congestive heart failure (CHF)) overlapped with the pneumococcal pneumonia group. This group showed substantial differences to the pneumococcal pneumonia group, with overall higher citrate, trigonelline and 1-methylnicotinamide, and lower myo-inositol and creatine levels.

Some metabolites that changed with pneumococcal infection (e.g. 3-hydroxybutyrate and acetone) may also be attributed to fasting²⁴. Since many patients with pneumococcal pneumonia may be unable to eat, and nearly all patients in our study did not present to the ED until several days after onset of symptoms, we sought to determine whether otherwise healthy individuals, when calorically restricted, might have a similar urinary profile to subjects with pneumococcal pneumonia. Urine samples were collected from patients presenting for routine colonoscopy (n=70), who had been fasting overnight and calorically restricted for at least 1 day. OPLS-DA revealed distinct differences between those who are fasting and those with pneumococcal pneumonia (R²=0.877; Q²=0.842) (FIG. 18f). Although the median concentrations of acetone and 3-hydroxybutyrate for the fasting and S. pneumoniae cohorts were similar, levels of carnitine and acetylcarnitine were significantly higher in the S. pneumoniae group (data not shown). Moreover, citrate and 1-methylnicotinamide levels were substantially higher in the fasting group versus the S. pneumoniae group.

Several metabolites (creatine, citrate, 2-oxoglutarate, lactate, acetate, and taurine) that were observed to be perturbed in the setting of infection, have been also been shown to be perturbed in hepatotoxicity²⁴. We investigated whether individuals with liver dysfunction would have a similar profile to those with pneumonia. We collected urine from 16 individuals with chronic hepatitis C (n=12) or cirrhosis (n=4) and compared these with our pneumococcal groups (see FIG. 18g). OPLS-DA revealed clear class distinction in the urinary metabolite profiles between those with either hepatitis C or cirrhosis, and those with pneumococcal pneumonia (R²=0.936; Q²=0.899). Interestingly, creatine, lactate, acetate and taurine were higher in the S. pneumoniae group whereas citrate was higher in the liver dysfunction group (data not shown). The concentration of 2-oxoglutarate was similar between the cohorts.

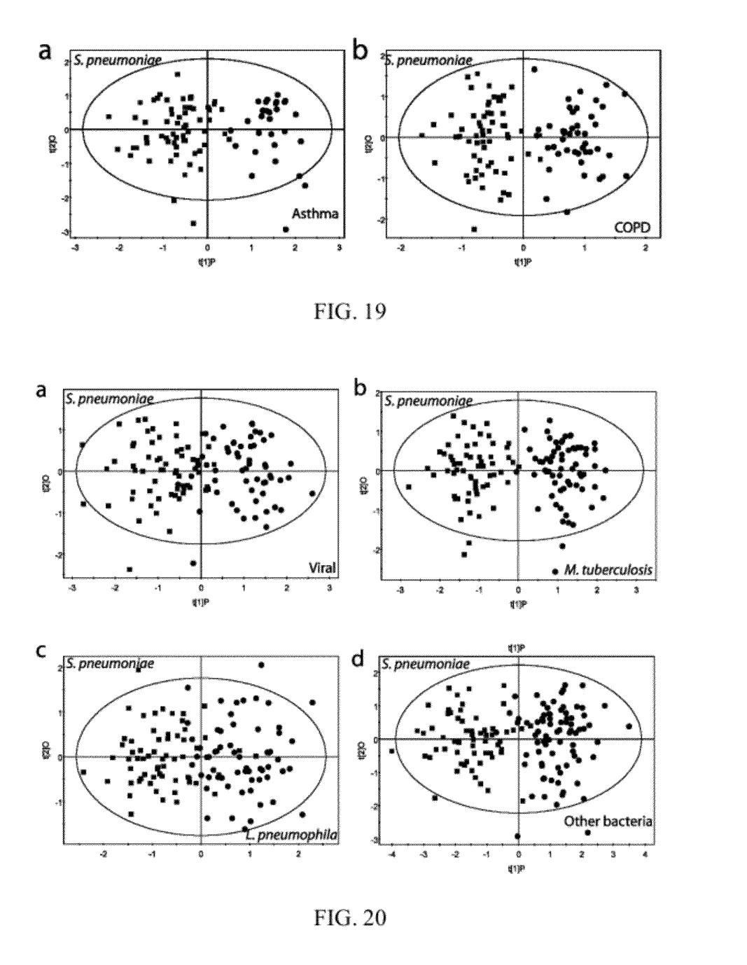

To determine whether other pulmonary diseases, such as COPD or asthma, have similar urinary metabolite profiles to S. pneumoniae infection, we compared individuals presenting to the ED with either asthma exacerbation (n=31) or COPD exacerbation (n=44) (see FIGS. 19a and 19b). OPLS-DA revealed distinction between pneumococcal pneumonia and either asthma (R²=0.776; Q²=0.676) or COPD (R²=0.804; Q²=0.638).

To establish whether the urinary metabolite profile of pneumococcal pneumonia differs from viral pneumonia, a total of 58 subjects (consisting of 16 patients with influenza A, 12 with picornavirus, 11 with RSV, 8 with parainfluenza viruses, 6 with coronavirus, 4 with hMPV, and 1 with hantavirus) were compared with 62 patients with pneumococcal pneumonia (FIG. 20a). A good separation between viral and pneumococcal pneumonia was observed in OPLS-DA plots (R²=0.665; Q²=0.486).

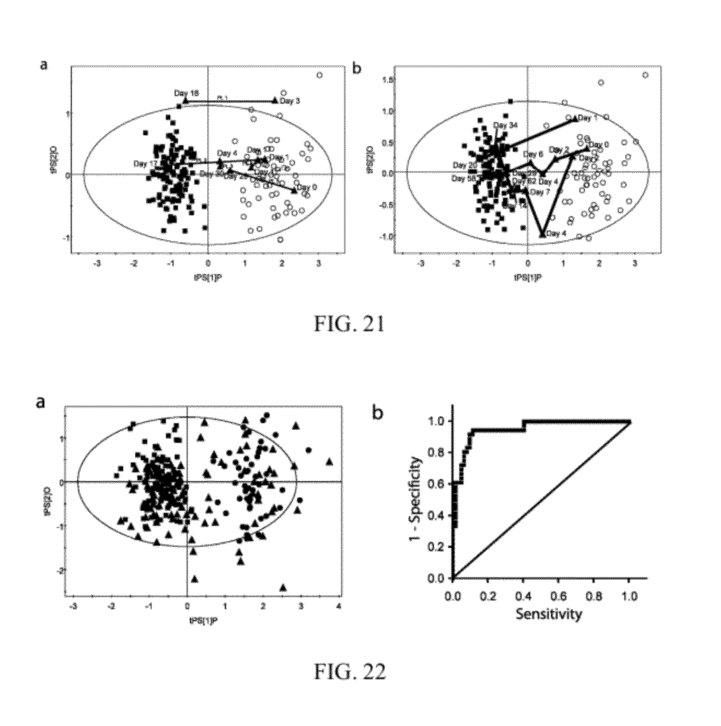

To investigate whether the observed urinary metabolic differences were specific for S. pneumoniae bacteria, a comparison was made to other types of bacterial pneumonia. The first comparison, to patients with tuberculosis, revealed excellent class distinction (R²=0.840; Q²=0.774) (FIG. 21b). Comparison of pneumococcal pneumonia with L. pneumophila infection also revealed some separation (FIG. 20c), however the predictive capacity of this model was not as good as for other models (R²=0.665; Q²=0.486). This cohort of individuals included those with Legionnaires' disease as well as those with Pontiac fever (a milder form of Legionnaires' disease).

Comparison of pneumococcal pneumonia to patients with pneumonia as a result of S. aureus (n=27), C. burnetii (n=15), H. influenzae (n=11), M. pneumoniae (n=9), E. coli (n=7), E. faecalis (n=3), M. catarrhalis (n=4), S. viridans (n=2), or S. anginosus (n=2) (FIG. 20d) revealed excellent separation between pneumonia due to these bacteria and pneumococcal pneumonia (R²=0.744; Q²=0.680).

To determine whether the profiles from patients with pneumococcal pneumonia return to a “normal” metabotype over time, we collected urine from patients admitted to the ED with pneumococcal pneumonia. At the time of enrollment, most patients had been given antibiotics for at least two days (FIGS. 21a and 21b). Serial urine samples were collected at various intervals for up to 62 days after initial presentation to hospital. Patient demographics are presented in Table 8.

As observed in FIGS. 21a and 21b, all patients with pneumococcal pneumonia were predicted to belong to the pneumococcal group with the first urine collection. As time progressed, a metabolic trajectory could be seen whereby each subject's metabotype changed from pneumococcal to normal. Two notable exceptions (FIG. 22a) were patients 3 and 4. The urine samples collected from patient 4 on days 1 and 11 were during intensive care. It was determined that patient 3 had COPD in addition to pneumococcal pneumonia. Patient 5 was admitted to hospital for a lengthy time, and had not fully recovered by day 29. Patient 2 was not as ill as the other patients, and therefore was able to achieve a full recovery by day 17. An interesting case study was patient 1, who had COPD, diabetes, renal failure (serum creatinine=457 μM) and a number of other health issues. We were able to observe him moving from a pneumococcal metabotype to a more normal metabolite phenotype (although he remains an outlier in the OPLS-DA plot).

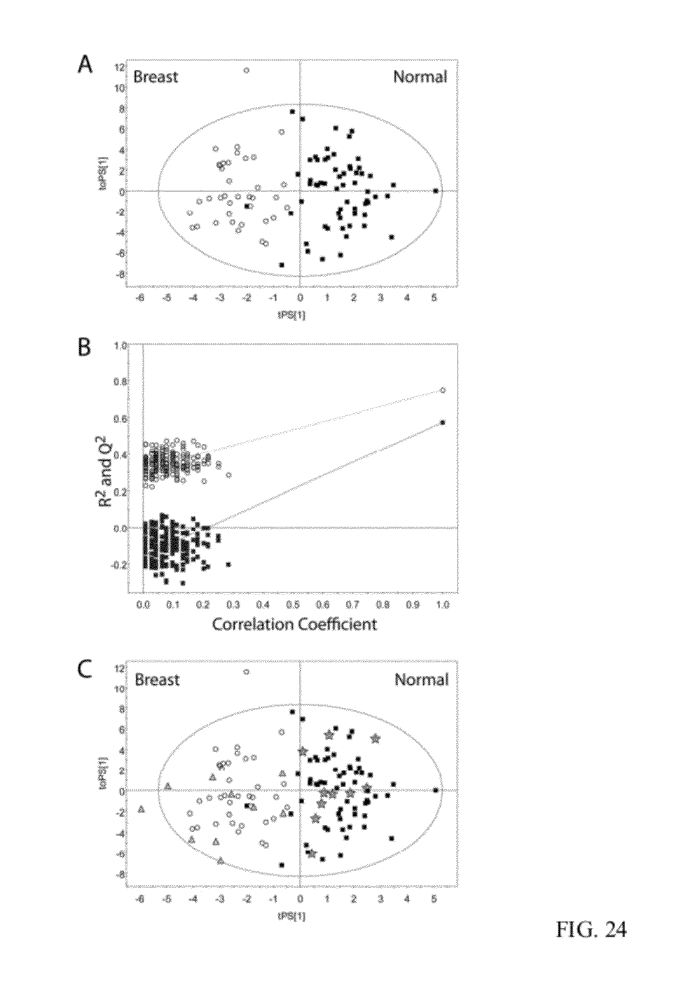

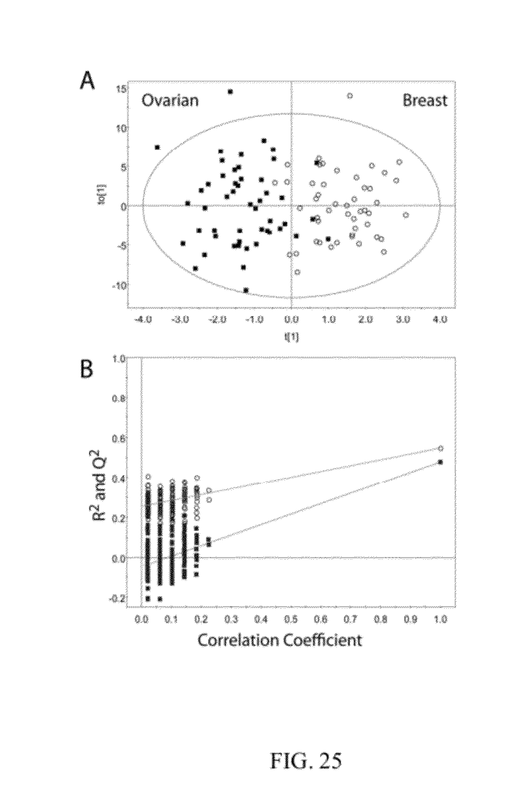

To test the robustness of the model in terms of sensitivity and specificity with only measured urinary metabolite concentrations, an independent sample set composed of 145 samples (age ranging from 2 to 90 years) was randomly selected by one of us (TJM) and presented as unknowns to CMS who performed testing and interpretation. In this sample set, there were 35 subjects with bacteremic pneumococcal pneumonia; 42 normal subjects; 9 with non-infectious metabolic stress; 14 with COPD or asthma; and 45 with pneumonia due to a variety of pathogens other than S. pneumoniae. An optimal set of metabolites was chosen based on significance and ease of spectral measurement (see Table 7), and these metabolites were measured for each spectrum in the blinded test. The predicted data are shown in FIG. 22a. Correct classification of pneumococcal pneumonia was achieved for 91% of cases. All of the false positives occurred for individuals with asthma, COPD or chronic heart failure. An ROC curve (FIG. 24b) with an AUC of 0.944 revealed that this test was both sensitive (86%) and specific (94%) for diagnosis of pneumococcal pneumonia.

Discussion: Some differences in profiles were found to potentially be masked by other diseases (for example HIV and cancer), but this methodology is shown here to be useful for the distinction between a variety of diseases and potentially could be used for screening of the general population.

TABLE 8
Selected features of patients in longitudinal pneumococcal study.

| | | | | | | | | | Days from | |
|---|---|---|---|---|---|---|---|---|---|---|
| | | | O₂ sat | | | | Chest | | antibiotic to | |
| | | | (%) at | pO₂ | pCO₂ | Temp | radiographic | Hospital | collection of first | |
| Patient | Gender | Age | room air | (mmHg) | (mmHg) | (° C.) | findings*** | stay (days) | urine sample | Co-morbidities |
| 1 | M | 60 | 83 | 44 | 35 | 39.1 | RLL, LLL, | 12 | 3 | Diabetes, heart disease, liver |
| | | | | | | | pleural effusion | | | disease, chronic renal failure |
| 2 | F | 53 | 90 | nd | nd | 36.7 | RLL | 8 | 1 | None |
| 3 | M | 65 | 90 | nd | nd | 37.6 | RML | 6 | 4 | COPD, diabetes, renal failure |
| 4 | F | 34 | 74 | 50 | 27 | 38.0 | RLL, perihilar | 41** | 1 | Substance abuse (non-alcohol), |
| | | | | | | | | | | Hepatitis C, |
| | | | | | | | | | | pulmonary fibrosis |
| 5 | F | 73 | 91 | 53 | 36 | 36.6 | RLL | 91*** | 0 | Hypertension, osteoporosis |
| 6 | M | 37 | 93 | 54 | 27 | 38.0 | LLL | 1 | 1 | COPD, substance abuse |
| | | | | | | | | | | (alcohol) |
| 7 | F | 70 | 90 | 55 | 29 | 38.8 | RLL, RML. | 10 | 0 | None |
| | | | | | | | RUL | | | |
| 8 | M | 69 | 74 | 70 | 35 | 35.5 | RLL, RML, | 7 | 2 | Diabetes, hypertension |
| | | | | | | | LLL, lingula | | | |

*Abbreviations: RLL: right lower lobe; LLL: left lower lobe; RML: right middle lobe; RUL: right upper lobe
**Both samples collected while patient was in intensive care.
***Patient had other complications including chronic obstructive pulmonary disease, and chronic respiratory failure requiring the lengthy hospital stay.

Serial collection of urine samples over the course of infection showed that individuals with a pneumococcal metabotype changed to a more normal metabotype indicating that the urinary profiles were specific to the infection, and that they resolved with treatment. Thus, these data indicate that we can detect pneumococcal disease, and track patient response to treatment.

Using a supplemental series of samples and clinical blinding, we demonstrated excellent sensitivity and specificity in identifying S. pneumoniae infection. Our results indicate a high accuracy rate (91%) for this approach. With respect to the subjects that failed in our test, seven were false positives, and examination of the clinical data associated with these cases suggested that a concomitant S. pneumoniae infection was possible (these subjects had conditions such as COPD, asthma and chronic heart failure). Importantly, none of the normal subjects were false positives. With a predicted rate of up to 10% colonization in the adult general population in North America, we would have expected more false positives if colonization generated a metabolic profile similar to that of infected individuals. Although colonization was not specifically confirmed in the control population (other than for 2 patients shown to be sputum positive but otherwise not ill with pneumonia), our results suggest that this test may be specific to infection by pneumococcal bacteria.

Of the false negative patients (five out of 35), no obvious explanation could be found based upon clinical data. Examination of metabolite profiles revealed a metabotype that was largely similar to that associated with pneumococcal disease. Visual inspection of the OPLS-DA plot revealed that these patients were questionable as to categorization. We believe that the potential misclassification resulted from extremely high citrate levels (−10 mM) for one patient (we expect the citrate concentration to be less than 1 mM for S. pneumoniae patients), and from a “normal” metabotypic level of two metabolites for the other false negative patients. We found that the concentrations of these two metabolites are typically high in infected individuals. Two of the false-negative patients were immunocompromised, one suffering from human immunodeficiency virus, and the other from cancer. We are continuing to investigate these findings. Of interest was the finding that the profile from children infected with S. pneumoniae was similar to that found for adults, even though the immune system of children differs from adults. We believe that these results show this test to be a general test for this pathogen, although clearly more study needs to be done since we only had 3 pediatric patients in our cohort, and two individuals who were immunocompromised.

Comparison of the urinary metabolite profiles from patients with pneumococcal pneumonia other lung infections revealed good separation. However, we determined that it was more difficult to separate those infected with Legionnaire's disease and S. pneumoniae.

Clearly, all clinicians would prefer tests with 100% sensitivity and specificity; however, this is rarely possible. The fact that two patients hospitalized for reasons other than a lung disease, both of which had a negative urinary metabolite test, but grew S. pneumoniae from sputum suggests that our test does not detect colonization. These preliminary results, in conjunction with the fact that none of the subjects in the healthy control population were false positives, are encouraging. Moreover, of particular significance in this study is the fact that the urine metabolite profile was able to discriminate between pneumococcal pneumonia and other causes of pneumonia. Most standard tests for viral or bacterial pneumonia are invasive, costly, time-consuming, complex and rarely available universally. Furthermore, these tests often do not have a high accuracy rate. It is accepted that even in the face of viral pneumonia, empiric treatment with antibiotics is recommended, as viral pneumonia can often be complicated by concomitant bacterial infection. Unfortunately, guidelines vary in treatment recommendations, and often a “shotgun” approach is taken where patients are given broad-based antibiotics to account for all types of infection. In the face of antibiotic resistant organisms emerging, this is not an ideal situation.

In summary, it was shown that NMR-based metabolomic analysis of patient urine can be used to diagnose a variety of diseases. A definitive metabolic profile specific to lung infection with S. pneumoniae was also seen in a mouse model (described in Example 2) indicating that the human profile arises from infection. Moreover, similarities were seen in metabolite changes for approximately ⅓ of the common metabolites found in mouse and human urine. Longitudinal studies in both mice and human subjects reveal that urinary metabolite profiles can return to “normal” values, and that the profile changes over the course of the disease.

### Example 2

In a mouse model of lung infection, we observed distinct differences between two different infecting pathogens (S. pneumoniae and S. aureus). Of interest, we observed TCA cycle intermediates to decrease, as well as fucose to increase in both mice and humans in response to S. pneumoniae infection. Changes in the concentration of TCA cycle intermediates could be due to the action of pneumolysin excreted by S. pneumoniae, as it has been shown that pneumolysin specifically targets mitochondria. Other changes in mitochondrial function are indicated by increased levels of tryptophan and quinolinate, and decreased levels of 1-methylnicotinamide, suggesting impairment of the nicotinamide metabolism pathway. Alterations of liver mitochondrial function are confirmed by the increase in the concentrations of valine, leucine, and isoleucine, as well as the rapid generation of ketone bodies and other indicators of fatty acid metabolism (carnitine and acetylcarnitine). Furthermore, increased levels of glucose, lactate, and creatine, and the osmolytes taurine, and myo-inositol, also suggest that the infectious process may involve the liver. Indeed, it has been shown in fulminant hepatic failure that TCA cycle intermediates decrease, and branched chain amino acids increase in concentration in the plasma. In our study, we also found substantial differences between those with S. pneumoniae and those with hepatitis or cirrhosis, indicating that our observed response cannot simply be explained by an altered liver functionality. Increased fucose could be caused by S. pneumoniae effecting a release of fucosylated host glycans, and decreases in trigonelline may be indicative of bacterial uptake for osmotolerance.

### Example 3

Rabies is a virus (Lyssavirus) that causes acute encephalitis in mammals. Transmission is usually through a bite as the virus is usually present in the nerves and saliva of a symptomatic rabid animal. After infection in a human, the virus enters the peripheral nervous system and continues to the central nervous system. Once the virus reaches the brain, it causes encephalitis. After onset of the first flu-like symptoms, partial paralysis occurs, followed by cerebral dysfunction, anxiety, insomnia, confusion, agitation, abnormal behavior, paranoia, terror, hallucinations which progress to delirium. Large quantities of saliva and tears coupled with the inability to speak or swallow constitute the later stages of the disease.

A man bitten by a bat in August, presented with symptoms in February of the following year. Over the course of 2 months, the man slowly progressed through the disease, and finally passed away. During this time, several samples of cerebral spinal fluid and urine were taken for comparative purposes. For some metabolites, similar trends were seen between cerebral spinal fluid (CSF) and urine.

### Example 4

A method will be provided for diagnosing cancer, for example, but not limited to breast and ovarian cancer, wherein a metabolic profile for the disease will be obtained and used as a reference profile. Thereafter, the metabolic profile will be obtained from a urine sample and compared to the reference profile, the results will be statistically analyzed and a diagnosis made.

### Example 5

A method will be provided for diagnosing metabolic stress wherein metabolically stressed includes, for example, but not limited to, obese, pregnant, anorexic, bulemic, cachexic, diabetic, having myocardial infarction, having congestive heart failure and trauma, including more than one condition. A metabolic profile for the stress will be obtained and used as a reference profile. Thereafter, the metabolic profile will be obtained from a urine sample and compared to the reference profile, the results will be statistically analyzed and a diagnosis made.

### Example 6

A method will be provided for diagnosing body disorders (non-infectious diseases) including, but not limited to, inflammatory bowel disease, including Crohn's Disease and ulcerative colitis, chronic obstructive pulmonary disease (COPD) and liver disease (e.g. cirrhosis), including more than one body disorder. A metabolic profile for the disorder will be obtained and used as a reference profile. Thereafter, the metabolic profile will be obtained from a urine sample and compared to the reference profile, the results will be statistically analyzed and a diagnosis made.

### Example 7

A method will be provided for assessing the efficacy of a treatment in improving or stabilizing patient health. The method will involve treating the subject with at least one of composition, a drug, a treatment, for example, but not limited to, an exercise regime, a diet, a therapy, for example, but not limited to chemotherapy, radiation treatment, angioplasty, wound closure, and a surgery, as would be known to one skilled in the art. Thereafter, the metabolic profile will be obtained from a urine sample and compared to a reference profile, obtained from a normalized healthy population or a healthy person, the patient prior to treatment, or a reference profile for the infectious disease, metabolic stress, cancer or non-infectious disease. Comparing the metabolic profile can continue during and after treatment. The metabolic profile could embody comparing drug and drug metabolites to determine efficacy, compliance, or unexpected drug toxicity or interactions. Furthermore, the metabolic profile could embody measuring drug or drug metabolites from drugs not to be taken by an individual (e.g. acetaminophen, alcohol).

### Example 8

An iterative or hierarchical programme for sequential and rapid clustering of biomarkers will be applied to the data for diseases, body disorders and conditions. The result will be a defined metric for each disease, body disorder and condition studied, and will therefore provide a rapid diagnosis of patient health with a higher probability of accuracy.

### Example 9

The methods described may also be used with respect to cancer. The present example relates to the detection of ovarian cancer (EOC) and breast cancer.

The test sample was made up of patients with breast cancer, patients with ovarian cancer, and healthy volunteers. The group with of patients with breast cancer included 48 females with either ductal carcinoma, ductal carcinoma in situ (DCIS), or lobular carcinoma. Tumor sizes ranged from <1 cm to 9 cm in diameter, with the majority between 1 and 2 cm. A total of 10 patients had at least one positive lymph node. They ranged in age from 30 to 86, with a median age of 56. Ten samples were randomly selected and set aside as a test set. The group of patients with ovarian cancer included 50 females with EOC. EOC patients were diagnosed with histopathological features and stages, for a total of: 2 with stage 1V, 32 with stage III, 2 with stage II, 10 with stage I, and 4 with undocumented stage. They ranged in age from 21 to 83 with a median age of 56. Ten samples were randomly selected and set aside as a test set. The group of healthy volunteers included 72 females with no known history of either breast or ovarian cancer, aged from 19 to 83 (median age 56). Ten samples were randomly selected and set aside as a test set.

Data Collection: Urine samples were obtained from volunteers, transferred into urine cups, and subsequently frozen within 1 hour at −20° C. followed by long-term storage at −80° C. Prior to NMR data collection, samples were thawed, and 585 μL of sample supernatant was mixed with 65 μL of internal standard (containing ˜5 mM DSS-d₆ (3-(trimethylsilyl)-1-propanesulfonic acid-d₆), 0.2% NaN₃, in 99.8% D₂O. For each sample, the pH was adjusted to 6.8±0.1 by adding small amounts of NaOH or HCl. 600 μL of sample was subsequently transferred into 5 mm 535 pp NMR tubes (Wilmad-LabGlass, Vineland, N.J.), and samples were stored at 4° C. until NMR acquisition (within 24 hours of sample preparation). NMR spectra were acquired as previously described (8). Metabolite identification and quantitation was accomplished through the technique of targeted profiling using Chenomx NMRSuite 4.6 (Chenomx, Inc. Edmonton, Canada).

Data Analysis: Metabolite identification and quantitation was accomplished through the technique of targeted profiling using Chenomx NMRSuite 4.6 (Chenomx, Inc. Edmonton, Canada). Metabolites were selected from a library of approximately 300 compounds. Of these 300 compounds, 67 metabolites could be identified in all spectra, 6 of which were tentative assignments and are indicated in the manuscript as “unknown singlet”. These metabolites accounted for more than 80% of the total spectral area. To account for variations in metabolite concentration due to dilute or concentrated urine, probabilistic quotient normalization of the metabolite variables using a median calculated spectrum was performed prior to chemometric and statistical analysis. Multivariate statistical data analysis (PCA, PLS-DA and OPLS-DA) was performed on log₁₀-transformed normalized metabolite concentrations, to account for the non-normal distribution of the concentration data, and reduce the chance of skewed variables, using SIMCA-P (version 11, Umetrics, Umeå, Sweden), with mean centering and unit variance scaling applied. Significance tests using Wilcoxon's rank-sum test was performed using GraphPad Prism version 4.0c for MacIntosh (GraphPad Software, San Diego, Calif.). Significance was determined after Bonferroni correction and set at α=0.0082.

The approach of probabilistic quotient normalization takes into account changes of the overall concentration of a sample and assumes that the intensity of a majority of signals is a function of dilution only. The method works by calculating the most probable quotient between concentrations of a sample of interest, and the concentrations of a reference spectrum, creating a distribution of quotients from which a normalization factor can be derived.

The method is as follows:
1. Remove metabolites that are not common between all spectra (such as drug metabolites), as well as urea and creatinine, and other metabolites that might dominate the integral normalization
2. Perform integral normalization to a particular constant (e.g. 100) for each sample
3. Calculate the median concentration for each metabolite in the control group.
4. For each metabolite in each sample, calculate the result of dividing the test metabolite concentration with the reference metabolite concentration
5. For each sample, calculate the median of the above result, which is the quotient normalization factor.
6. In the original sample file (that includes all metabolites), multiply each metabolite in each sample by the quotient normalization factor for that sample.

The data is now normalized to a reference.

The method is applied to metabolite concentrations (rather than a spectral normalization), and all metabolite concentrations are removed that would dominate the calculation of the integral normalization (such as creatinine which is an order of magnitude greater in concentration than most other metabolites, urea which is several orders of magnitude greater, and drug metabolite concentrations which would not be present in all samples).

Results—Comparison of 67 metabolite concentrations measured in urine from a cohort of female, apparently healthy subjects (n=62) and subjects with ovarian cancer (n=40) revealed substantial differences. Application of orthogonal partial least-squares-discriminant analysis (OPLS-DA) to the data set resulted in distinction between individuals with EOC and those that were healthy (FIG. 1A). One healthy individual in the learning set appeared in the cancer category, and one cancer individual appeared in the healthy category. Model parameters for the explained variation, R2, and the predictive capability Q2, were significantly high (R2=0.77; Q2=0.60), and validation of the PLS-DA is suggestive of an excellent model (FIG. 1B). OPLS-DA class prediction was performed on a total of 20 subjects that were not used in the generation of the model, 10 each of ovarian cancer and healthy subjects (FIG. 1C). For ease of presentation, those subjects with ovarian cancer were later indicated as grey triangles, and those that were “healthy” were later indicated as grey stars. As may be observed, all test subjects were correctly predicted as either ovarian cancer or normal.

Comparison of 67 metabolite concentrations from healthy (n=62) and subjects with breast cancer (n=38) revealed significant differences. Application of OPLS-DA to this dataset resulted in distinction between individuals with breast cancer and those without (FIG. 2A). Five of the healthy individuals overlapped with the breast cancer category. The model parameters and validation of the PLS-DA suggested a good model (R2=0.75; Q2=0.57) (FIG. 2B). OPLS-DA class prediction was performed as for the EOC subjects, on a total of 20 subjects, 10 each of breast cancer and healthy (FIG. 2C). As may be observed, all breast cancer and healthy test subjects were correctly classified.

Analysis of urinary metabolite changes revealed that many metabolites decreased in relative concentration with a cancer (both EOC and breast) phenotype when compared to healthy (Table 1). However, the extent of the change was different for each of ovarian and breast cancers. For example, the singlet at 3.35 ppm tentatively assigned as methanol, was ranked as the most important metabolite responsible for separating EOC patients, with a 65% decrease in concentration relative to normal subjects. For breast cancer patients, this metabolite was ranked as the thirty-first important metabolite, with a 46% decrease in concentration. In fact, there are several metabolites that are significantly different between breast and ovarian cancers (Table 2), and comparison of breast and ovarian cancer metabolite profiles revealed good separation (FIG. 3). Certain metabolites, such as propylene glycol and mannitol, which strictly come from ingestion, were unchanged in concentration between healthy, ovarian or breast cancer (data not shown).

Discussion—This study demonstrates for the first time that urinary metabolic profiling shows changes in metabolite concentrations that can be specifically correlated with breast or ovarian cancer, and that at least two types of cancer can be sub-typed using urine metabolomics. Remarkably, we discovered that nearly all metabolites that were significantly different between the cancers and normal were lower in concentration in both the EOC and breast cancer groups as compared to normal. As the data was normalized to account for dilution, the explanation was not one of excess fluid intake by the cancer patients.

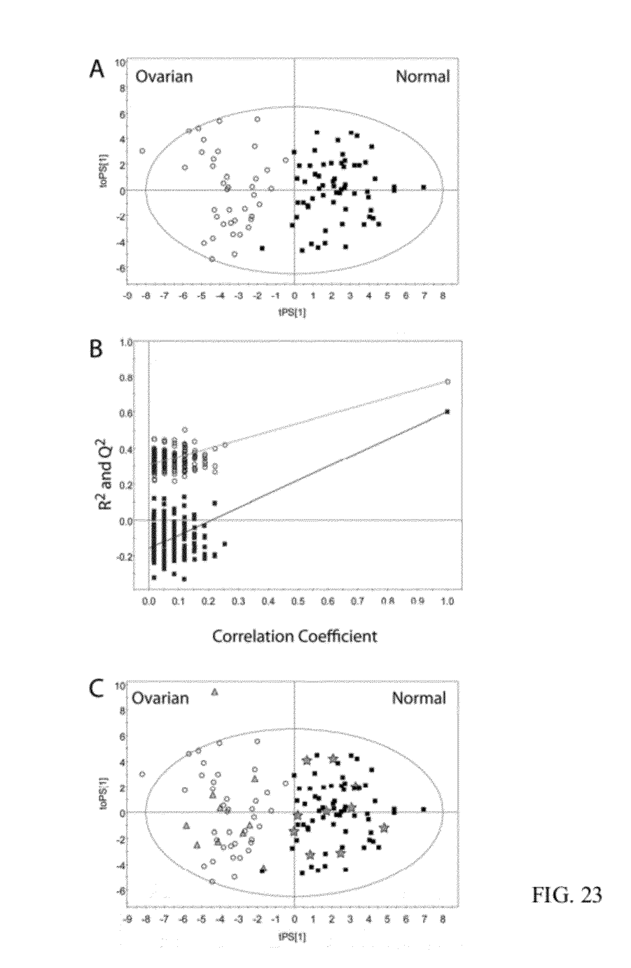

In these datasets, there were few misclassifications. In the ovarian cancer model, the “healthy” individual who overlapped with the ovarian cancer patients was a 61 y/o with arthritis and GERD. The misclassified EOC patient was 79 y/o with stage 1C papillary serous and a CA-125 level over 35. At this time, it is not known why her profile appeared on the edge of the healthy cohort. Interestingly, 10 of the ovarian cancer patients had CA-125 levels less than 35, and the metabolomics test was able to detect these cancers. In the breast cancer model, there was one “healthy” individual that was clearly classified as breast cancer, and another four that appeared on the edge of the breast cancer category. None of the breast cancer patients overlapped with the “healthy” cohort. Of interest, all five of these individuals were 60 years of age and older, and one (the square marker on the lower left of FIG. 24a just inside the breast cancer cohort) is the same individual that appeared in the ovarian cancer category on the ovarian cancer model plot (FIG. 23a).

That the majority of urinary metabolites appeared to decrease in concentration in cancer patients is a similar result to what has been seen in colon cancer tissue metabolomics. Interestingly, some metabolites that were shown to increase in cancer tissue (such as some of the amino acids) were lower in the urine of cancer patients. Our results are in agreement with other publications involving measurements of metabolites in blood, where concentrations of many amino acids decrease in cancer patients relative to healthy. Decreases in TCA cycle intermediates are suggestive of a suppressed TCA cycle. In a study of urinary markers of colorectal cancer, it was observed that several TCA cycle intermediates decrease in those with colorectal cancer as compared to those without. The biological reason behind the metabolite changes is largely speculative at this point, but likely involves a shift in energy production, as tumors rely primarily on glycolysis as their main source of energy. This phenomenon is known as the Warburg effect, and decreases in TCA cycle intermediates as well as glucose in the urine could be indicative of this phenomenon. Clearly, lower glucose concentrations were observed in women with ovarian cancer as compared with breast cancer. This could be due to the fact that more of the women with ovarian cancer were in advanced stage disease. Furthermore, the use of amino acids by tumors requires the up-regulation of amino acid transporters, pulling these metabolites from the blood. Decreases in circulating glucose and amino acids could subsequently result in an overall decrease in energy metabolism elsewhere in the body, diminishing other metabolic pathways such as the urea cycle, resulting in lower concentrations of urea and creatine and potentially affecting gut microbial population and/or metabolism. These observations will undoubtedly be the subject of future studies.

The fact that we found almost no false negatives (98% and 100% sensitivity for ovarian and breast cancer respectively), and few false positives (99% and 93% specificity for ovarian and breast cancer respectively) suggest that our test would be an effective screening tool with no harmful side effects. Indeed breast mammography, where the number of false positives and false negatives are many times what we have demonstrated, has resulted in a significant decrease in mortality. We suggest that our novel urine test is faster, easier to administer, less costly and non-invasive and could be used as a pre-screen to other forms of more invasive or uncomfortable screening. The majority of the breast cancers in this study were small ductal carcinomas and even DCIS, that is, very small cancers that were confined to the breast tissue, and they were easily detected by our methods. We have shown that metabolomics is proving useful as a potential screening tool. In the future, we will undertake a study of a larger prospective cohort to further validate the accuracy of this test.

In summary, patients with either breast or ovarian cancer show distinct changes in their urinary metabolite signature. Urinary metabolite measurements have the capacity to revolutionize cancer detection, and potentially cancer treatment if the early stage can be identified and treated.

### Example 10

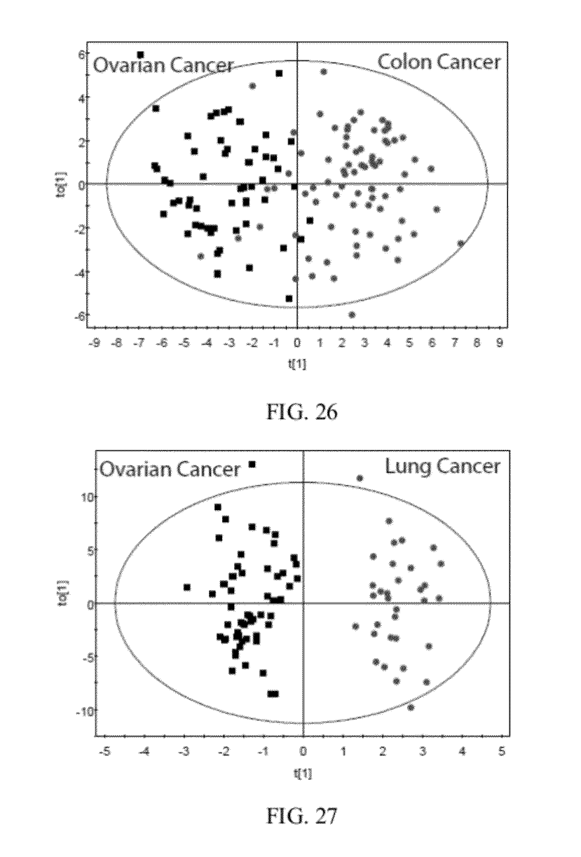

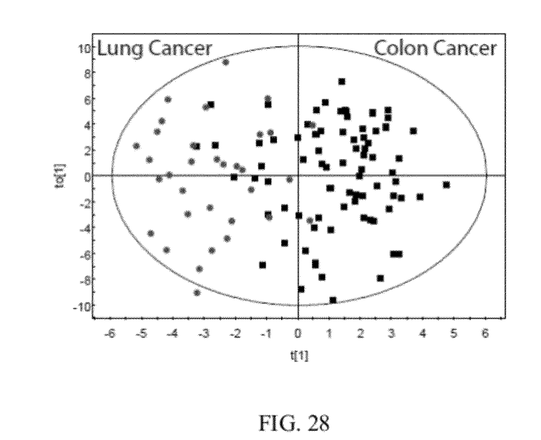

Example 9 relates to ovarian and breast cancer. Similar principles may be applied to other cancers. For example, FIG. 26 compares ovarian cancer and colon cancer, FIG. 27 compares ovarian cancer and lung cancer, and FIG. 28 compares lung cancer to colon cancer. Each were generated using techniques similar to those described used for ovarian and breast cancer. Table 9 shows the metabolite changes in human urine with breast and ovarian cancer when compared to a healthy group and Table 10 shows the metabolite changes in human urine of ovarian cancer when compared to a breast cancer group.

TABLE 9
Metabolite Changes in Human Urine with Breast and Ovarian Cancer
When Compared To a Healthy Group

| | Healthy versus | | | Healthy versus | | |
|---|---|---|---|---|---|---|
| | Ovarian Cancer | | | Breast Cancer | | |
| | % | | | % | | |
| Metabolite^{a} | Change^{b} | p-value^{c} | rank^{d} | Change^{b} | p-value^{c} | rank^{d} |
| Unknown | −80 | <0.0001 | 6 | −67 | 0.0005 | 19 |
| singlet @ | | | | | | |
| 4.34 ppm | | | | | | |
| Creatine | −77 | <0.0001 | 3 | −75 | 0.0010 | 23 |
| Acetate | −74 | <0.0001 | 5 | −68 | <0.0001 | 9 |
| Succinate | −71 | <0.0001 | 4 | −70 | <0.0001 | 2 |
| Levoglucosan | −65 | <0.0001 | 14 | — | 0.0141 | 39 |
| Unknown | −65 | <0.0001 | 1 | −46 | <0.0001 | 31 |
| singlet at | | | | | | |
| 3.35 ppm | | | | | | |
| Lactate | −64 | <0.0001 | 7 | −59 | <0.0001 | 36 |
| Pyroglutamate | −63 | <0.0001 | 19 | −48 | 0.0003 | 15 |
| Formate | −62 | <0.0001 | 8 | −43 | <0.0001 | 1 |
| Isoleucine | −61 | <0.0001 | 9 | −43 | <0.0001 | 11 |
| Sucrose | −61 | <0.0001 | 12 | −39 | 0.0016 | 24 |
| Unknown | −60 | <0.0001 | 32 | −51 | 0.0009 | 26 |
| singlet @ | | | | | | |
| 3.94 ppm | | | | | | |
| Trigonelline | −59 | <0.0001 | 28 | — | 0.0099 | 33 |
| Leucine | −59 | <0.0001 | 10 | −52 | <0.0001 | 6 |
| Asparagine | −58 | <0.0001 | 15 | −51 | <0.0001 | 7 |
| Urea | −58 | <0.0001 | 2 | −37 | <0.0001 | 13 |
| Glucose | −58 | <0.0001 | 30 | −42 | 0.0081 | 52 |
| Ethanolamine | −56 | <0.0001 | 22 | −48 | 0.0003 | 18 |
| Dimethylamine | −55 | 0.0001 | 31 | −41 | 0.0003 | 17 |
| 4- | −55 | <0.0001 | 11 | −50 | <0.0001 | 14 |
| Hydroxy- | | | | | | |
| phenylacetate | | | | | | |
| Creatinine | −54 | <0.0001 | 26 | −42 | 0.0001 | 12 |
| Alanine | −54 | <0.0001 | 13 | −42 | 0.0003 | 16 |
| Unknown | −54 | 0.0004 | 42 | −39 | 0.0012 | 37 |
| singlet @ | | | | | | |
| 2.36 ppm | | | | | | |
| Hippurate | −54 | <0.0001 | 23 | −49 | <0.0001 | 5 |
| 1-Methyl- | −53 | <0.0001 | 18 | — | 0.0650 | 51 |
| nicotinamide | | | | | | |
| Unknown | −52 | <0.0001 | 24 | — | 0.1832 | 62 |
| singlet @ | | | | | | |
| 3.79 ppm | | | | | | |
| Uracil | −52 | <0.0001 | 28 | −52 | <0.0001 | 4 |
| Valine | −52 | <0.0001 | 20 | −47 | 0.0008 | 22 |
| Unknown | −50 | <0.0001 | 16 | −44 | <0.0001 | 10 |
| singlet @ | | | | | | |
| 2.60 ppm | | | | | | |
| trans- | −49 | <0.0001 | 21 | −46 | 0.0003 | 20 |
| Aconitate | | | | | | |

^{a}Metabolites ranked according to % Change for Ovarian Cancer patients.
^{b}Change calculated as difference in median concentration between Cancer and Healthy group. Only those values which are significant after Bonferroni correction are indicated.
^{c}P-value calculated using Wilcoxon rank-sum test.
^{d}Variable rank was determined from the OPLS-DA variable importance to projection (VIP) for the two models.

TABLE 10
Metabolite Changes in Human Urine of Ovarian
Cancer When Compared to a Breast Cancer Group

| Metabolite^{a} | % Change^{b} | p-value^{c} | rank^{d} |
|---|---|---|---|
| Acetone | 84 | 0.0002 | 36 |
| Allantoin | 80 | 0.0006 | 2 |
| Unknown singlet @ 3.79 ppm | 70 | 0.0021 | 5 |
| Carnitine | 57 | 0.0005 | 1 |
| Methanol | 55 | 0.0015 | 7 |
| Urea | 49 | 0.0007 | 3 |
| 1-Methylnicotinamide | 49 | 0.0034 | 4 |
| Levoglucosan | 39 | 0.0060 | 8 |
| Unknown singlet @ 2.82 ppm | −63 | 0.0022 | 6 |

^{a}Metabolites ranked according to % Change for Ovarian Cancer patients.
^{b}Change calculated as difference in median concentration between Cancer and Healthy group.
^{c}P-value calculated using Wilcoxon rank-sum test.
^{d}Variable rank was determined from the OPLS-DA variable importance to projection (VIP) for the model.

The foregoing are descriptions of different examples. As would be known to one skilled in the art, other variations are contemplated. For example, the bodily fluid can be, for example, but not limited to, follicular fluid, seminal plasma, uterine lining fluid, plasma, blood, spinal fluid, serum, interstitial fluid, sputum, or saliva. Further, the profiles may be obtained using, for example, but not limited to, one or more of high pressure liquid chromatography (HPLC), thin layer chromatography (TLC), electrochemical analysis, mass spectroscopy, refractive index spectroscopy (R1), Ultra-Violet spectroscopy (UV), fluorescent analysis, radiochemical analysis, Near-InfraRed spectroscopy (Near-IR), Nuclear Magnetic Resonance spectroscopy (NMR), gas chromatography (GC), microfluidics and Light Scattering analysis (LS). Other technologies that can be employed include, but are not limited to, colorimetric or radiometric means otherwise known in the art, a human or machine readable strip, in which the presence of the compounds, relative to a control, is detectable through a colorimetric change in the human or machine readable strip via a chemical reaction between a compound present in or on the human or machine readable strip and at least one of the compounds a human or machine readable strip, in which the presence of the compounds, relative to a control, is detectable through a colorimetric change in the human or machine readable strip via a chemical reaction between a compound present in or on the human or machine readable strip and at least one other molecule wherein at least one of the at least one other molecule interacts preferentially with at least one the of components. Further, the method may have applications in risk assessment and early detection of health issues.

We have shown that the method described above can be used to characterize various diseases using samples obtained in a similar fashion for each characterization. These diseases include different types of cancers, bacterial infections, and viral infections, and occur in different areas of the body. Accordingly, it becomes clear that metabolomics can be used to characterize any condition that causes a metabolic disturbance in the body.

1. A method for assessing patient health, the method comprising:
providing a sample of bodily fluid from a subject;
collecting a metabolic profile from the bodily fluid, the metabolic profile comprising two or more metabolites along with small organic molecules derived in vivo from the two or more metabolites, the two or more metabolites and small organic molecules being present in the bodily fluid; and
comparing the metabolic profile to at least one reference profile to assess the health of the subject, the at least one reference profile profiling at least one of: one or more disease, injury or disorder of the blood and blood-forming organs, one or more immune mechanism disorder, one or more auto-immune disease, one or more endocrine system disease, injury or disorder, one or more nutritional disease, one or more metabolic disease, one or more disease, injury or disorder of the nervous system, one or more disease, injury or disorder of the eye, one or more disease, injury or disorder of the adnexa of the eye, one or more disease, injury or disorder of the ear, one or more disease, injury or disorder of the mastoid process, one or more disease, injury or disorder of the circulatory system, one or more disease, injury or disorder of the digestive system, one or more disease, injury or disorder of the skin and subcutaneous tissue, one or more disease, injury or disorder of the musculoskeletal system and connective tissue, one or more disease, injury or disorder of the genitourinary system, one or more viral infection of the respiratory system, one or more chronic disorder of the respiratory system, tuberculosis, and one or more neoplasm.

2. The method of claim 1, wherein the at least one reference profile is at least one of ovarian cancer, breast cancer, and colon cancer, tuberculosis, hepatitis C, cirrhosis, fractures, myocardial infarcts, lacerations, congestive heart failure, fasting, Mycobacterium tuberculosis, Legionella pneumophila, Coxiella burnetii, Staphylococcus aureus, Mycoplasma pneumoniae, and Haemophilus influenza, influenza A, parainfluenza, respiratory syncycial virus (RSV), picorna virus, corona virus, rhinovirus, human metapneumovirus (hMPV) and hantavirus.

3. The method of claim 1, further comprising statistically analyzing differences between the metabolic profile and reference profile to identify at least one biomarker.

4. The method of claim 3, further comprising rejecting biomarkers or a group of biomarkers having a significance level of less than 95%.

5. The method of claim 1, wherein the metabolites of at least one of the metabolic profile and the reference profile are selected from a group consisting of 1,3-dimethylurate, levoglucosan, 1-methylnicotinamide, metabolite 1,2-hydroxyisobutyrate, 2 oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2, metabolite 3, hippurate, histidine, hypoxanthine, isoleucine, lactate, leucine, lysine, mannitol, metabolite 4, metabolite 5, metabolite 6, N,N-dimethylglycine, O-acetylcarnitine, pantothenate, propylene glycol, pyroglutamate, pyruvate, quinolinate, serine, succinate, sucrose, metabolite 7, taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

6. The method of claim 1, wherein the bodily fluid is urine.

7. The method of claim 1, wherein the profiles are obtained using Nuclear Magnetic Resonance spectroscopy.

8. The method of claim 1, wherein the reference profile is established from the metabolic profile collected from subjects with the same disease.

9. The method of claim 1, wherein the reference profile is established from reference profiles collected from a healthy population.

10. The method of claim 1, further comprising monitoring by repeatedly comparing, over time, the metabolic profile to the reference profile.

11. The method of claim 1, wherein the subject is metabolically stressed.

12. The method of claim 4, further comprising rejecting biomarkers or a group of biomarkers having a significance level of less than 97%.

13. The method of claim 12, further comprising rejecting biomarkers or a group of biomarkers having a significance level of less than 98%.

14. The method of claim 13, further comprising rejecting biomarkers or a group of biomarkers having a significance level of less than 99%.

15. The method of claim 1, further comprising:
treating the subject at least one of before and after providing the sample of bodily fluid from the subject; and
comparing the metabolic profile to a reference profile to assess the efficacy or toxicity of the treatment in treating the subject.

16. A kit for performing the method according to claim 1, wherein the kit comprises reference biomarkers and necessary reagents for performing the comparison.

17. A reference profile for assessing patient health, the profile comprising two or more metabolites along with small organic molecules derived in vivo from the two or more metabolites that are differentially present at a level that is statistically significant, the profile profiling at least one of one or more disease, injury or disorder of the blood and blood-forming organs, one or more immune mechanism disorder, one or more auto-immune disease, one or more endocrine system disease, injury or disorder, one or more nutritional disease, one or more metabolic disease, one or more disease, injury or disorder of the nervous system, one or more disease, injury or disorder of the eye, one or more disease, injury or disorder of the adnexa of the eye, one or more disease, injury or disorder of the ear, one or more disease, injury or disorder of the mastoid process, one or more disease, injury or disorder of the circulatory system, one or more disease, injury or disorder of the digestive system, one or more disease, injury or disorder of the skin and subcutaneous tissue, one or more disease, injury or disorder of the musculoskeletal system and connective tissue, one or more disease, injury or disorder of the genitourinary system, one or more viral infection of the respiratory system, one or more chronic disorder of the respiratory system, tuberculosis, and one or more neoplasm.

18. The reference profile of claim 17, wherein the reference profile is obtained from a urine sample.

19. A method of characterizing a metabolite in a sample, the method comprising:
providing a sample of bodily fluid from a subject;
analyzing the bodily fluid to obtain spectral data of the sample;
processing the spectral data using baseline correction and line width normalization; and
comparing the processed spectral data to at least one reference spectrum to characterize the metabolite.

20. The method of claim 19, further comprising characterizing a plurality of metabolites in the sample to obtain a metabolic profile of the sample.

21. The method of claim 20, wherein the processed spectral data is compared to a mathematical representation of the reference spectrum.

22. The method of claim 20, wherein the metabolic profile comprises a reference profile of a disease, injury or disorder of the blood and blood-forming organs, an immune mechanism disorder, an auto-immune disease, an endocrine system disease, injury or disorder, a nutritional disease, a metabolic disease, a disease, injury or disorder of the nervous system, a disease, injury or disorder of the eye, a disease, injury or disorder of the adnexa of the eye, a disease, injury or disorder of the ear, a disease, injury or disorder of the mastoid process, a disease, injury or disorder of the circulatory system, a disease, injury or disorder of the digestive system, a disease, injury or disorder of the skin and subcutaneous tissue, a disease, injury or disorder of the musculoskeletal system and connective tissue, a disease, injury or disorder of the genitourinary system, a viral infection of the respiratory system, a chronic disorder of the respiratory system, tuberculosis, and a neoplasm.

23. The method of claim 20, wherein the metabolic profile comprises two or more of 1,3-dimethylurate, levoglucosan, 1-methylnicotinamide, metabolite 1, 2-hydroxyisobutyrate, 2-oxoglutarate, 3-aminoisobutyrate, 3-hydroxybutyrate, 3-hydroxyisovalerate, 3-indoxylsulfate, 4-hydroxyphenylacetate, 4-hydroxyphenyllactate, 4-pyridoxate, acetate, acetoacetate, acetone, adipate, alanine, allantoin, asparagine, betaine, carnitine, citrate, creatine, creatinine, dimethylamine, ethanolamine, formate, fucose, fumarate, glucose, glutamine, glycine, metabolite 2, metabolite 3, hippurate, histidine, hypoxanthine, isoleucine, lactate, leucine, lysine, mannitol, metabolite 4, metabolite 5, metabolite 6, N,N-dimethylglycine, O-acetylcarnitine, pantothenate, propylene glycol, pyroglutamate, pyruvate, quinolinate, serine, succinate, sucrose, metabolite 7, taurine, threonine, trigonelline, trimethylamine-N-oxide, tryptophan, tyrosine, uracil, urea, valine, xylose, cis-aconitate, myo-inositol, trans-aconitate, 1-methylhistidine, 3-methylhistidine, ascorbate, phenylacetylglutamine, 4-hydroxyproline, and gluconate, galactose, galactitol, galactonate, lactose, phenylalanine, proline betaine, trimethylamine, butyrate, propionate, isopropanol, mannose, 3-methylxanthine, ethanol, benzoate, glutamate and glycerol.

24. The method of claim 21, wherein the spectral data is obtained using Nuclear Magnetic Resonance spectroscopy.

25. The method of claim 21, wherein the spectral data is phase shifted.

26. The method of claim 20, further comprising applying an apodization function.

27. The method of claim 20, wherein obtaining the spectral data comprises zero-filling or linear prediction.

28. The method of claim 20, further comprising the step of characterizing more than one metabolite using relative peak position, J-coupling, and line width information.
